(19) United States
(12) Patent Application Publication
(10) Pub. No.: US 2007/0192803 A1
(43) Pub. Date: Aug. 16, 2007

(54) Broadcast receiving device, viewing management server, viewing determination method, broadcasting system, viewing determination program, and storage medium

(75) Inventor: Masanobu Chisaka, Chiba-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/367,506

(22) Filed: Mar. 6, 2006

(30) Foreign Application Priority Data
Feb. 15, 2006 (JP) 2006-038507

(51) Int. Cl. H04N 7/173; H04N 5/445; G06F 3/00; H04N 7/16; G06F 13/00

(52) U.S. Cl. 725/61; 725/87; 725/135

(57) ABSTRACT

A broadcast data receiving section receives broadcasted broadcast data. A reception confirmation key extracting section extracts reception confirmation keys from the broadcast data. A reception confirmation processing section counts the extracted reception confirmation keys. A viewing determination section determines that a viewer has watched a program when the thus counted number of reception confirmation keys exceeds a reference value. This makes it possible to more accurately determine whether the viewer has watched the program.

This Nonprovisional application claims priority under 35 U.S.C. § 119(a) on Patent Application No. 38507/2006 filed in Japan on Feb. 15, 2006, the entire contents of which are hereby incorporated by reference.

### FIELD OF THE INVENTION

The present invention relates to a broadcast receiving device which receives broadcast programs, a viewing management server, viewing determination method, broadcasting system, viewing determination program, and storage medium.

### BACKGROUND OF THE INVENTION

Conventionally, audience rating surveys have been carried out by using special metering equipments installed in individual households. Such a method ensured effective measurement of audience ratings in analogue broadcasting. Recently, mobile communications terminals, such as mobile telephones, have been capable of receiving broadcast programs. In the case of the mobile communications terminals, the special metering equipments conventionally used in the households do not work for a reliable measurement of audience ratings.

In view of this, some techniques have been suggested for more accurate measurement of program ratings.

Japanese Unexamined Patent Publication No. 320341/2001 (Tokukai 2001-320341; published on Nov. 16, 2001) discloses a digital broadcasting system in which program information is broadcasted in digital fashion, wherein a content for viewing time measurement is broadcasted, the amount of time spent for watching a program by a viewer is measured by means of the foregoing content, and services are offered by the measured amount of time spent for watching the program by the viewer.

Japanese Unexamined Patent Publication No. 271286/2002 (Tokukai 2002-271286; published on Sep. 20, 2002) discloses a viewing data collection system for digital broadcasting. The system allows for the collection of audience survey data by including audience survey conducting means which causes a nonvolatile storage section to store identification information of a broadcast station or a broadcast program, at regular time intervals, together with a time when the identification information is stored, and transfers the data stored in the nonvolatile storage section to a center server through a communications line interface. The data stored in the nonvolatile storage section is transferred to the center server at regular time intervals greater than those at which the identification information is stored.

Japanese Unexamined Patent Publication No. 346231/2001 (Tokukai 2001-346231; published on Dec. 14, 2001) discloses a broadcast receiver. The broadcast receiver includes: program information acquiring means which acquires, from a transmission signal, program information unique to a program in reception; history creating means which checks for latest program information having been acquired by the program information acquiring means, at each timing; and history transmitting means which causes data transmitting means to transmit, to a predetermined collection center, notification information including at least (i) viewing history information, which is created by the history creating means and (ii) predetermined user identification information.

Japanese Unexamined Patent Publication No. 313920/2001 (Tokukai 2001-313920; published on Nov. 9, 2001) discloses a method for offering an incentive to viewers who make entries for a broadcast campaign. The method includes the step of transmitting a request for adding to a point account for a viewer a predetermined number of points as an incentive for the entry to the campaign, in a point system for a particular point company where points corresponding to a viewer selected point type are issued in accordance with data, included in entry information, describing the viewer selected point type.

Japanese Unexamined Patent Publication No. 60928/2001 (Tokukai 2001-60928; published on Mar. 6, 2001) discloses a broadcasting system including: (a) a broadcast transmitting device and (b) a plurality of broadcast receiving devices. The broadcast transmitting device generates sets of individual information which are individually set for broadcast viewing subscribers, adds audience rating survey target information indicative of a target for audience rating survey to individual information for a target subscriber selected for the audience rating survey from among the broadcast viewing subscribers, and combines the individual information with a broadcast for its transmission. Each of the broadcast receiving devices receives the broadcast, and performs an audience rating survey process if the audience rating survey target information is added to the individual information.

Japanese Unexamined Patent Publication No. 32500/2000 (Tokukai 2000-32500; published on Jan. 28, 2000) discloses a program selection history information obtaining method. The method is for obtaining selection history information of programs selected by a receiving device from among multiple channels. The method includes: the step of storing program selection information at a predetermined time interval; the step of displaying a predetermined icon at a predetermined time interval; the step of determining whether the icon has been selected within a given time period after the display of the icon and storing a result of the determination; and the step of transmitting the stored selection information and the determination result at a predetermined time interval.

Japanese Unexamined Patent Publication No. 57588/1992 (Tokukaihei 4-57588; published on Feb. 25, 1992) discloses a CATV audience rating survey method. In the method, upon receipt of a current time and a viewing unit time for storing viewing channel data, a home terminal stores viewing channel data by the viewing unit time in accordance with the current time, and a center arbitrarily collects the stored viewing channel data from the home terminal.

Japanese Unexamined Patent Publication No. 86341/1984 (Tokukaisho 59-86341; published on May 18, 1984) discloses a data collection method. In the method, a marker signal is transmitted by airwaves so that individual households can receive the marker signal, data on a device used in each of the households having received the marker signal is temporarily stored, and the device is caused to automatically call a certain telephone number at the conclusion of a predetermined elapsed time after the reception of the marker signal so that the stored data is collected through a general telephone line.

Japanese Unexamined Patent Publication No. 123694/2005 (Tokukai 2005-123694; published on May 12, 2005) discloses a video distribution system having a data center. The data center includes: a determination section which selects a user ID of a user who has watched a video program for more than a certain amount of time, in accordance with viewing information having been transmitted from a broadcast station server; and an advertisement mail distribution section which reads out from a mail address database a mail address corresponding to a user ID selected by the determination section, reads out from an advertisement information database advertisement information corresponding to the video program, and distributes, to the mail address having been read out from the mail address database, an advertisement mail attached with the advertisement information having been read out from the advertisement information database.

However, the techniques disclosed in the foregoing patent documents cannot accurately determine whether a viewer has watched a program. For example, the conventional techniques have the problem of regarding a viewer as having watched a first program even in the situation where the viewer switches to the first program for a brief moment and then switches to a second program quickly. That is, such a method is unreliable.

### SUMMARY OF THE INVENTION

The present invention has been attained to solve the above problem, and an objective thereof is to provide a broadcast receiving device, a viewing management server, a viewing determination method, a broadcasting system, a viewing determination program, and a storage medium, all of which enable more accurate determination as to whether a viewer has watched a program.

In order to solve the above problem, a broadcast receiving device according to the present invention is a broadcast receiving device which receives a broadcast program and sequentially receives a plurality of reception confirmation keys by which reception of the broadcast program is confirmed, the broadcast receiving device comprising: reception means which receives the reception confirmation keys; and viewing determination means which determines that a viewer has watched the broadcast program, when number of the reception confirmation keys, which have been received by the reception means, exceeds a predetermined reference value.

According to the above arrangement, the broadcast receiving device receives a broadcast program. Further, the broadcast receiving device sequentially receives, together with the broadcast program, a plurality of reception confirmation keys by which reception of the broadcast program is confirmed. For example, the reception confirmation keys are combined with program data in advance.

In the broadcast receiving device, the reception means receives the reception confirmation keys. In receiving the reception confirmation keys, the reception means counts the reception confirmation keys. Then, the viewing determination means compares the number of reception confirmation keys having been received by the reception means with a predetermined reference value. The reference value is a value representing a standard used in order to determine whether a viewer has watched a particular program. The viewing determination means determines that the viewer has watched the program, when the number of reception confirmation keys exceeds the reference value.

As described previously, the broadcast receiving device does not determine that a viewer has watched a program until it receives a certain number of reception confirmation keys. In the situation where the viewer has happened to switch to a particular program and quickly switched to another program, the broadcast receiving device determines that the viewer has not watched the particular program. This is because the number of reception confirmation keys to be received does not reach a certain reference value. Thus, the broadcast receiving device brings the effect of more accurately determining whether the viewer has watched the program.

In order to solve the above problem, a viewing determination method according to the present invention includes: reception step of receiving a broadcast program and sequentially receiving a plurality of reception confirmation keys by which reception of the broadcast program is confirmed; and viewing determination step of determining that a viewer has watched the broadcast program, when number of the reception confirmation keys, which have been received in the reception step, exceeds a predetermined reference value.

According to the above arrangement, the viewing determination method brings the same operation and effect as those that the foregoing broadcast receiving device brings.

In order to solve the above problem, a viewing management server according to the present invention includes: reception means which receives information transmitted from a broadcast receiving device, the broadcast receiving device receiving a broadcast program and sequentially receiving a plurality of reception confirmation keys by which reception of the broadcast program is confirmed, the information being information regarding the reception confirmation keys that the broadcast receiving device has received; number-of-reception-confirmation-keys calculating means which calculates number of the reception confirmation keys, which have been received by the broadcast receiving device, in accordance with the information having been received by the reception means; and viewing determination means which determines that a viewer has watched the broadcast program, when the thus calculated number of the reception confirmation keys exceeds a predetermined reference value.

According to the above arrangement, the viewing management server brings the same operation and effect as those that the foregoing broadcast receiving device brings.

In order to solve the above problem, the broadcast receiving device according to the present invention is a broadcast receiving device which receives a broadcast program and sequentially receives a plurality of reception confirmation keys by which reception of the broadcast program is confirmed, the broadcast receiving device comprising: reception means which receives the reception confirmation keys; and viewing determination means which determines that a viewer has watched the broadcast program, (a) when the reception means has received at least one predetermined particular reception confirmation key among the reception confirmation keys and (b) when number of the reception confirmation keys, which have been received by the reception means, exceeds a predetermined reference value.

According to the above arrangement, the broadcast receiving device receives a broadcast program. Further, the broadcast receiving device sequentially receives, together with the broadcast program, a plurality of reception confirmation keys by which reception of the broadcast program is confirmed. For example, the reception confirmation keys are combined with program data in advance.

In the broadcast receiving device, the reception means receives the reception confirmation keys. In receiving the reception confirmation keys, the reception means counts the reception confirmation keys. Then, the viewing determination means compares the number of reception confirmation keys having been received by the reception means with a predetermined reference value. The reference value is a value representing a standard used in order to determine whether a viewer has watched a particular program.

Here, the viewing determination means determines that the viewer has watched the broadcast program, (a) when the reception means has received at least one predetermined particular reception confirmation key among the reception confirmation keys and (b) when the number of the reception confirmation keys, which have been received by the reception means, exceeds a predetermined reference value. The particular reception confirmation key is set at an important scene in the program, for example. The fact that a particular reception confirmation key has been received means a high possibility that the viewer has watched a particular scene in a program.

As described previously, the broadcast receiving device does not determine that a viewer has watched a program until it receives a particular reception confirmation key and receives a certain number of reception confirmation keys. In the situation where the viewer has happened to switch to a particular program and quickly switched to another program, the broadcast receiving device determines that the viewer has not watched the particular program. This is because the number of reception confirmation keys to be received does not reach a certain reference value. Further, in the situation where the viewer is not so eager to watch the program and just watches some scenes of the program, the broadcast receiving device determines that the viewer has not watched the program. This is because the particular reception confirmation key has not been received.

Thus, the broadcast receiving device brings the effect of more accurately determining whether the viewer has watched the program.

In order to solve the above problem, the viewing determination method according to the present invention includes: reception step of receiving a broadcast program and sequentially receiving a plurality of reception confirmation keys by which reception of the broadcast program is confirmed; and viewing determination step of determining that a viewer has watched the broadcast program, (a) when at least one predetermined particular reception confirmation key among the reception confirmation keys has been received in the reception step and (b) when number of the reception confirmation keys, which have been received by the reception means, exceeds a predetermined reference value.

According to the above arrangement, the viewing determination method brings the same operation and effect as those that the foregoing broadcast receiving device brings.

In order to solve the above problem, the viewing management server according to the present invention includes: reception means which receives information transmitted from a broadcast receiving device, the broadcast receiving device receiving a broadcast program and sequentially receiving a plurality of reception confirmation keys by which reception of the broadcast program is confirmed, the information being information regarding the reception confirmation keys that the broadcast receiving device has received; number-of-reception-confirmation-keys calculating means which calculates number of the reception confirmation keys, which have been received by the broadcast receiving device, in accordance with the information having been received by the reception means; particular key reception determination means which determines whether the broadcast receiving device has received at least one predetermined particular reception confirmation key among the reception confirmation keys, in accordance with the information having been received by the reception means; and viewing determination means which determines that a viewer has watched the broadcast program, (a) when the particular key reception determination means determines that the broadcast receiving device has received the at least one predetermined particular reception confirmation key among the reception confirmation keys and (b) when the number of the reception confirmation keys, which has been calculated by the number-of-reception-confirmation-keys calculating means, exceeds a predetermined reference value.

According to the above arrangement, the viewing management server brings the same operation and effect as those that the foregoing broadcast receiving device brings.

In order to solve the above problem, the broadcast receiving device according to the present invention is a broadcast receiving device which receives a broadcast program and sequentially receives a plurality of reception confirmation keys by which reception of the broadcast program is confirmed, the broadcast receiving device comprising: reception means which receives the reception confirmation keys; reception points calculating means which calculates reception points by adding respective individual points for the received reception confirmation keys, the individual points being predetermined for each of the reception confirmation keys; and viewing determination means which determines that a viewer has watched the broadcast program, when the reception points thus calculated exceed a predetermined reference value.

According to the above arrangement, the broadcast receiving device receives a broadcast program. Further, the broadcast receiving device sequentially receives, together with the broadcast program, a plurality of reception confirmation keys by which reception of the broadcast program is confirmed. For example, the reception confirmation keys are combined with program data in advance.

In the broadcast receiving device, the reception means receives the reception confirmation keys. For the respective reception confirmation keys, individual points are set in advance. For example, “10” points are set for a first reception confirmation key, and “20” points are set for a second reception confirmation key.

The reception points calculating means adds the respective individual points for the received reception confirmation keys, the individual points being predetermined for each of the reception confirmation keys. In such a manner, the reception points calculating means calculates the reception points which are the total of the respective individual points. For example, when the reception means receives the first and second reception confirmation keys, the reception points calculating means calculates 30 points as the reception points by 10+20=30.

In the broadcast receiving device, the viewing determination means compares the reception points having been calculated by the reception points calculating means with a predetermined reference value. The reference value is a value representing a standard used in order to determine whether a viewer has watched a particular program. The viewing determination means determines that the viewer has watched the program, when the reception points exceed the reference value.

As described previously, the broadcast receiving device does not determine that a viewer has watched a program until the reception points exceed a certain value. In the situation where the viewer has happened to switch to a particular program and quickly switched to another program, the broadcast receiving device determines that the viewer has not watched the particular program. This is because the reception points do not reach a certain reference value.

Thus, the broadcast receiving device determines that the viewer has watched the program, when conditions set for a high possibility that the viewer has watched the program are satisfied. Thus, it is possible to bring the effect of more accurately determining whether the viewer has watched the program.

In order to solve the above problem, the viewing determination method according to the present invention includes: reception step of receiving a broadcast program and sequentially receiving a plurality of reception confirmation keys by which reception of the broadcast program is confirmed; reception points calculating step of calculating reception points by adding respective individual points for the received reception confirmation keys, the individual points being predetermined for each of the reception confirmation keys; and viewing determination step of determining that a viewer has watched the broadcast program, when the reception points thus calculated exceed a predetermined reference value.

According to the above arrangement, the viewing determination method brings the same operation and effect as those that the foregoing broadcast receiving device brings.

In order to solve the above problem, the viewing management server according to the present invention includes: reception means which receives information transmitted from a broadcast receiving device, the broadcast receiving device receiving a broadcast program and sequentially receiving a plurality of reception confirmation keys by which reception of the broadcast program is confirmed, the information being information regarding the reception confirmation keys that the broadcast receiving device has received; reception points calculating means which calculates reception points by adding respective individual points for the received reception confirmation keys, in accordance with the information having been received by the reception means, the individual points being predetermined for each of the reception confirmation keys; and viewing determination means which determines that a viewer has watched the broadcast program, when the reception points thus calculated exceed a predetermined reference value.

According to the above arrangement, the viewing management server brings the same operation and effect as those that the foregoing broadcast receiving device brings.

In order to solve the above problem, the broadcast receiving device according to the present invention is a broadcast receiving device which receives a broadcast program and sequentially receives a plurality of reception confirmation keys by which reception of the broadcast program is confirmed, the broadcast receiving device comprising: reception means which receives the reception confirmation keys; reception points calculating means which calculates reception points by adding respective individual points for the received reception confirmation keys, the individual points being predetermined for each of the reception confirmation keys; and viewing determination means which determines that a viewer has watched the broadcast program, (a) when the reception means has received at least one predetermined particular reception confirmation key among the reception confirmation keys and (b) when the reception points thus calculated exceed a predetermined reference value.

According to the above arrangement, the broadcast receiving device receives a broadcast program. Further, the broadcast receiving device sequentially receives, together with the broadcast program, a plurality of reception confirmation keys by which reception of the broadcast program is confirmed. For example, the reception confirmation keys are combined with program data in advance.

In the broadcast receiving device, the reception means receives the reception confirmation keys. For the respective reception confirmation keys, individual points are set in advance. For example, “10” points are set for a first reception confirmation key, and “20” points are set for a second reception confirmation key.

The reception points calculating means adds the respective individual points for the received reception confirmation keys, the individual points being predetermined for each of the reception confirmation keys. In such a manner, the reception points calculating means calculates the reception points which are the total of the respective individual points. For example, when the reception means receives the first and second reception confirmation keys, the reception points calculating means calculates 30 points as the reception points by 10+20=30.

In the broadcast receiving device, the viewing determination means compares the reception points having been calculated by the reception points calculating means with a predetermined reference value. The reference value is a value representing a standard used in order to determine whether a viewer has watched a particular program.

Here, the viewing determination means determines that the viewer has watched the broadcast program, (a) when the reception means has received at least one predetermined particular reception confirmation key among the reception confirmation keys and (b) when the reception points exceed a reference value. The particular reception confirmation key is set at an important scene in the program, for example. The fact that a particular reception confirmation key has been received means a high possibility that the viewer has watched a particular scene in a program.

As described previously, the broadcast receiving device does not determine that a viewer has watched a program until the reception points exceed a certain value. In the situation where the viewer has happened to switch to a particular program and quickly switched to another program, the broadcast receiving device determines that the viewer has not watched the particular program. This is because the reception points do not reach a certain reference value. Further, in the situation where the viewer is not so eager to watch the program and just watches some scenes of the program, the broadcast receiving device determines that the viewer has not watched the program. This is because the particular reception confirmation key has not been received.

Thus, the broadcast receiving device determines that the viewer has watched the program, when conditions set for a high possibility that the viewer has watched the program are satisfied. Thus, it is possible to bring the effect of more accurately determining whether the viewer has watched the program.

In order to solve the above problem, the viewing determination method according to the present invention includes: reception step of receiving a broadcast program and sequentially receiving a plurality of reception confirmation keys by which reception of the broadcast program is confirmed; reception points calculating step of calculating reception points by adding respective individual points for the received reception confirmation keys, the individual points being predetermined for each of the reception confirmation keys; and viewing determination step of determining that a viewer has watched the broadcast program, (a) when at least one predetermined particular reception confirmation key among the reception confirmation keys has been received in the reception step and (b) when the reception points thus calculated exceed a predetermined reference value.

According to the above arrangement, the viewing determination method brings the same operation and effect as those that the foregoing broadcast receiving device brings.

In order to solve the above problem, the viewing management server according to the present invention includes: reception means which receives information transmitted from a broadcast receiving device, the broadcast receiving device receiving a broadcast program and sequentially receiving a plurality of reception confirmation keys by which reception of the broadcast program is confirmed, the information being information regarding the reception confirmation keys that the broadcast receiving device has received; reception points calculating means which calculates reception points by adding respective individual points for the received reception confirmation keys, in accordance with the information having been received by the reception means, the individual points being predetermined for each of the reception confirmation keys; particular key reception determination means which determines whether the broadcast receiving device has received at least one predetermined particular reception confirmation key among the reception confirmation keys, in accordance with the information having been received by the reception means; and viewing determination means which determines that a viewer has watched the broadcast program, (a) when the particular key reception determination means determines that the broadcast receiving device has received the at least one predetermined particular reception confirmation key among the reception confirmation keys and (b) when the reception points thus calculated by the reception points calculating means exceeds a predetermined reference value.

According to the above arrangement, the viewing management server brings the same operation and effect as those that the foregoing broadcast receiving device brings.

In order to solve the above problem, the broadcast receiving device according to the present invention is a broadcast receiving device which receives a broadcast program, comprising: reception means which receives the broadcast program; question presenting means which, while the reception means receives the broadcast program, presents a question about the broadcast program to a viewer of the broadcast program; and viewing determination means which determines that the viewer has watched the broadcast program, when the viewer has answered the presented question correctly.

According to the above arrangement, in the broadcast receiving device, the reception means receives a program. Here, while the reception means receives the program, the question presenting means presents a question about the program. For example, the question presenting means can cause a display device to display the question thereon, or can cause a sound reproducer to reproduce sound corresponding to the question.

In the broadcast receiving device, the viewing determination means determines whether the viewer has answered the question correctly. When the viewer has answered the question correctly, the viewing determination means determines that the viewer has watched the program.

As described above the broadcast receiving device does not determine that the viewer has watched the program until the viewer answers the question about the program correctly. In the situation where the viewer does not watch the program at all although the broadcast receiving device is receiving the program, the broadcast receiving device determines that the viewer has not watched the program. This is because the viewer does not answer the question, or because the viewer having glanced at the question answers the question at a guess and the answer is incorrect.

Thus, the broadcast receiving device determines that the viewer has watched the program, when conditions set for a high possibility that the viewer has watched the program are satisfied. Thus, it is possible to bring the effect of more accurately determining whether the viewer has watched the program.

In order to solve the above problem, the viewing determination method according to the present invention includes: reception step of receiving a broadcast program; question presenting step of, while the broadcast program is received in the reception step, presenting a question about the broadcast program to a viewer of the broadcast program; and viewing determination step of determining that the viewer has watched the broadcast program, when the viewer has answered the presented question correctly.

According to the above arrangement, the viewing determination method brings the same operation and effect as those that the foregoing broadcast receiving device brings.

In order to solve the above problem, the viewing management server according to the present invention includes: question presenting means which causes a broadcast receiving device, which receives a broadcast program, to present a question about the broadcast program to a viewer of the broadcast program, after confirming that the broadcast receiving device has received the broadcast program in accordance with information having been transmitted from the broadcast receiving device; and viewing determination means which determines that the viewer has watched the broadcast program, when the viewer has answered the presented question correctly.

According to the above arrangement, the viewing management server brings the same operation and effect as those that the foregoing broadcast receiving device brings.

In order to solve the above problem, the broadcast receiving device according to the present invention is a broadcast receiving device which receives a broadcast program and receives at least one reception confirmation key by which reception of the broadcast program is confirmed, the broadcast receiving device comprising: reception means which receives the reception confirmation key; question presenting means which, after the reception means has received the reception confirmation key, presents a question about the broadcast program to a viewer of the broadcast program; and viewing determination means which determines that the viewer has watched the broadcast program, when the viewer has answered the presented question correctly.

According to the above arrangement, the broadcast receiving device receives a broadcast program. Further, the broadcast receiving device sequentially receives, together with the broadcast program, at least one reception confirmation key by which reception of the broadcast program is confirmed. For example, each reception confirmation key is combined with program data in advance.

In the broadcast receiving device, the reception means receives a reception confirmation key. After the reception means receives the reception confirmation key, the question presenting means presents a question about the program to a viewer. For example, the question presenting means can cause a display device to display the question thereon, or can cause a sound reproducer to reproduce sound corresponding to the question.

In the broadcast receiving device, the viewing determination means determines whether the viewer has answered the question correctly. When the viewer has answered the question correctly, the viewing determination means determines that the viewer has watched the program.

As described above the broadcast receiving device does not determine that the viewer has watched the program until the viewer answers the question about the program correctly. In the situation where the viewer does not watch the program at all although the broadcast receiving device is receiving the program, the broadcast receiving device determines that the viewer has not watched the program. This is because the viewer does not answer the question, or because the viewer having glanced at the question answers the question at a guess and the answer is incorrect. Further, in the situation where the viewing confirmation key is not received, the question is not presented to the viewer. Thus, the viewer can concentrate on watching the program. Moreover, it is possible for the broadcast receiving device to eliminate an act of the viewer, such as just answering the question without watching the program.

Thus, the broadcast receiving device determines that the viewer has watched the program, when conditions set for a high possibility that the viewer has watched the program are satisfied. Thus, it is possible to bring the effect of more accurately determining whether the viewer has watched the program. Moreover, it is possible to avoid needless confusion for the viewer.

In order to solve the problem, the viewing determination method according to the present invention includes: reception step of receiving a broadcast program and receiving at least one reception confirmation key by which reception of the broadcast program is confirmed; question presenting step of, after the reception confirmation key has been received in the reception step, presenting a question about the broadcast program to a viewer of the broadcast program; and viewing determination step of determining that the viewer has watched the broadcast program, when the viewer has answered the presented question correctly.

According to the above arrangement, the viewing determination method brings the same operation and effect as those that the foregoing broadcast receiving device brings.

In order to solve the problem, the viewing management server according to the present invention includes: question presenting means which causes a broadcast receiving device, which receives a broadcast program and receives at least one reception confirmation key by which reception of the broadcast program is confirmed, to present a question about the broadcast program to a viewer of the broadcast program, after confirming that the broadcast receiving device has received the reception confirmation key in accordance with information having been transmitted from the broadcast receiving device; and viewing determination means which determines that the viewer has watched the broadcast program, when the viewer has answered the presented question correctly.

According to the above arrangement, the viewing management server brings the same operation and effect as those that the foregoing broadcast receiving device brings.

In order to solve the above problem, a broadcasting system according to the present invention includes: any of the foregoing broadcast receiving devices; and a broadcast transmitting device which transmits the program and the reception confirmation keys to the broadcast receiving device.

The above arrangement brings the effect of providing a broadcasting system which more accurately determines whether the viewer has watched a program. In this broadcasting system, each broadcast transmitting device determines whether the viewer has watched the program. This eliminates the need for a special server for the viewing determination.

In order to solve the above problem, the broadcasting system according to the present invention includes: any of the foregoing viewing management servers; and the foregoing broadcast receiving device.

The above arrangement brings the effect of providing a broadcasting system which more accurately determines whether the viewer has watched a program. In this broadcasting system, the viewing management server determines whether the viewer has watched the program, in accordance with information supplied from a broadcast transmitting device. This realizes more simple configuration of each of the broadcast receiving devices and reduce the load on each of the broadcast receiving devices.

The broadcast receiving device may be realized by a computer. In this arrangement, the present invention also includes: a viewing determination program which causes a computer to operate as the foregoing respective means so that the broadcast receiving device can be realized by the computer; and a computer-readable storage medium storing the viewing determination program.

Further, the viewing management server may be realized by a computer. In this arrangement, the present invention also includes: a viewing determination program which causes a computer to operate as the foregoing respective means so that the viewing management server can be realized by the computer; and a computer-readable storage medium storing the viewing determination program.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a block diagram illustrating main components of a broadcasting system 1 according to First Embodiment.

FIG. 2 is a view illustrating an example of a structure of broadcast data.

FIG. 3 is a view illustrating a structure of a reference value management table.

FIG. 4 is a flowchart illustrating a flow of a process performed by the broadcasting system according to First Embodiment.

FIG. 5 is a view illustrating a structure of a viewing result table.

FIG. 6 is a view illustrating an example of broadcast data including combined EPG data.

FIG. 7(a) is a view illustrating a structure of broadcast data including combined serial-numbered reception confirmation keys.

FIG. 7(b) is a view illustrating a structure of broadcast data including combined serial-numbered reception confirmation keys.

FIG. 8 is a view illustrating a structure of program management table.

FIG. 9 is a block diagram illustrating the broadcasting system where a viewing determination section is provided in a broadcast data receiver.

FIG. 10 is a view illustrating a structure of broadcast data including combined reception confirmation keys each of which includes an identifier for identifying the reception confirmation key.

FIG. 11 is a view illustrating a point management table.

FIG. 12 is a view illustrating a structure of a reference value management table.

FIG. 13 is a flowchart illustrating a flow of a process performed by the broadcasting system according to Second Embodiment.

FIG. 14 is a view illustrating a point management table.

FIG. 15 is a block diagram illustrating main components of a broadcasting system according to Third Embodiment.

FIG. 16 is a view illustrating broadcast data including one question data combined in advance.

FIG. 17 is a view illustrating a structure of a question management table.

FIG. 18 is a view illustrating a display device on which a question about a program is shown up.

FIG. 19 is a flowchart illustrating a flow of a process performed by the broadcasting system according to Third Embodiment.

FIG. 20 is a view illustrating an example of a reward point management table.

FIG. 21 is a view illustrating a cumulative points management table.

FIG. 22 is a view illustrating broadcast data including plural sets of question data combined in advance.

### DESCRIPTION OF THE EMBODIMENTS

### First Embodiment

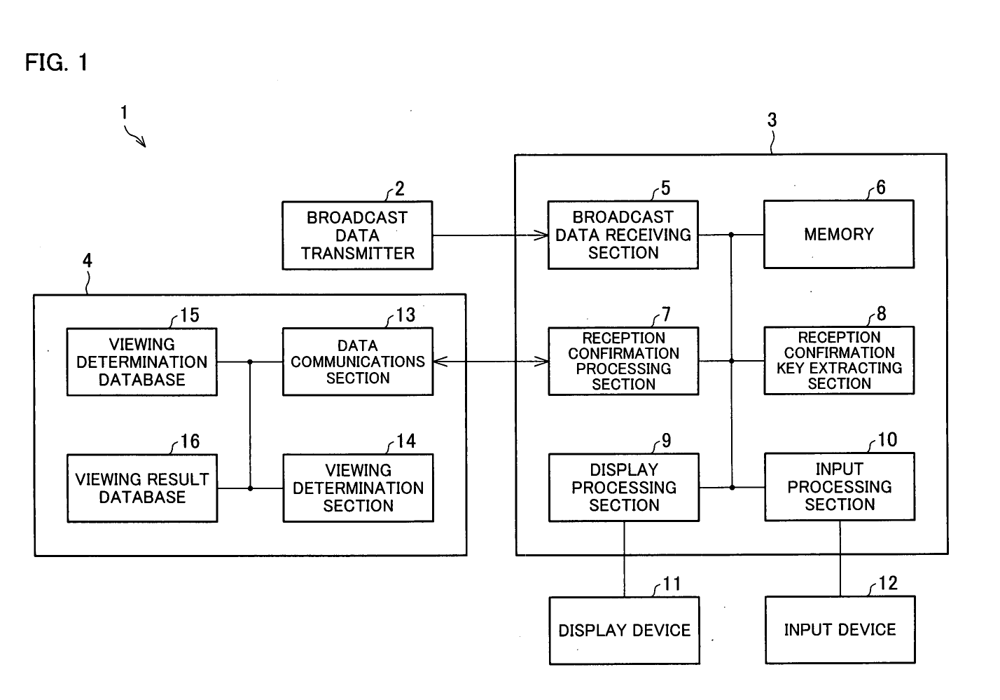

The following will describe First Embodiment of the present invention with reference to FIGS. 1 through 12.

(Broadcasting System 1)

The structure of a broadcasting system 1 according to the present invention will be described below with reference to FIG. 1. FIG. 1 is a diagram illustrating main components of the broadcasting system 1 according to First Embodiment. As illustrated in FIG. 1, the broadcasting system 1 includes a broadcast data transmitter 2 (broadcast transmitting device), a broadcast data receiver 3 (broadcast receiving device), and a viewing management server 4.

Here, the broadcast data receiver 3 is provided with a broadcast data receiving section 5 (reception means), a memory 6, a reception confirmation processing section 7 (number-of-reception-confirmation-keys calculating means; particular key reception determination means), a reception confirmation key extracting section 8, a display processing section 9 (question presenting means; informing means), an input processing section 10, a display device 11, and an input device 12. Meanwhile, the viewing management server 4 is provided with a data communications section 13, a viewing determination section 14 (viewing determination means; reception points calculating means; number-of-reception-confirmation-keys calculating means; particular key reception determination means; and incentive offering means), a viewing determination database 15, and a viewing result database 16.

The broadcast data transmitter 2 transmits broadcast data to the broadcast data receiver 3. The broadcast data contains program data representing a broadcast program. The broadcast data receiver 3 receives the broadcast data transmitted from the broadcast data transmitter 2, and causes the display device 11 to display the broadcast program. This allows a viewer to watch the program on the display device 11.

(Broadcast Data 20)

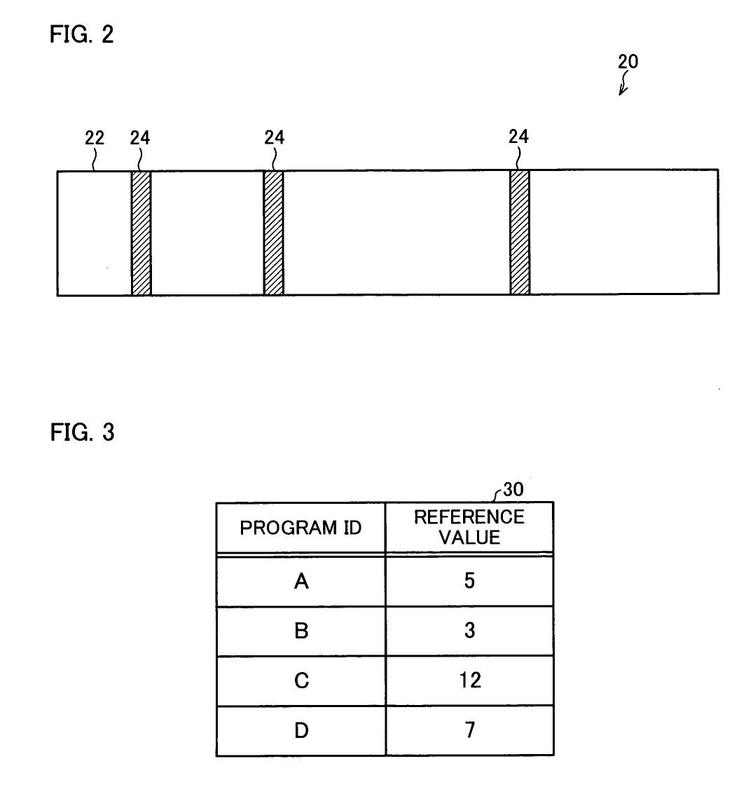

In the present embodiment, the broadcast data transmitter 2 transmits broadcast data 20 constructed as illustrated in FIG. 2 to the broadcast data receiver 3. FIG. 2 is a view illustrating an example of the structure of the broadcast data 20. As illustrated in FIG. 2, the broadcast data 20 includes program data 22 and a plurality of reception confirmation keys 24 combined with the program data 22.

The program data 22 is data representing a program. The reception confirmation key 24 is data used in determining whether the program represented as the program data 22 has been received by the broadcast data receiving section 5. The data of the reception confirmation key 24 has at least a structure identifiable as the reception confirmation key 24. More specifically, the reception confirmation key 24 may or may not contain information for identifying the program represented by the program data 22. Further, the reception confirmation key 24 may or may not contain information indicating a scene of the program corresponding to a location where the reception confirmation key 24 is combined with the program data 22.

(Extraction of Reception Confirmation Keys 24)

The broadcast data receiver 3 extracts the reception confirmation keys 24 from the received broadcast data 20. Then, the broadcast data receiver 3 counts the number of the reception confirmation keys 24 extracted, and transmits a counting result to the viewing management server 4.

The viewing management server 4 compares the count of the reception confirmation keys 24, which having been transmitted from the broadcast data receiver 3, with a predetermined reference value. As a result of the comparison, when the count is greater than the reference value, it is determined that a viewer has watched the program.

In order to perform the comparison, the viewing management server 4 uses a reference value management table 30 illustrated in FIG. 3. In the viewing management server 4, the reference value management table 30 is provided in advance in the viewing determination database 15. FIG. 3 is a view illustrating the structure of the reference value management table 30. As illustrated in FIG. 3, the reference value management table 30 has stored therein (i) a program ID which identifies a program and (ii) the reference value. The reference value is a standard used to determine whether the viewer has watched a program. The program ID and the reference value are associated with each other.

For example, in the reference value management table 30, an identifier “program A” is associated with a reference value “5”. An identifier “program B” is associated with a reference value “3”. Further, an identifier “program C” is associated with a reference value “12”. An identifier “program D” is associated with a reference value “7”.

For example, when the count of the reception confirmation keys 24 extracted from the broadcast data 20 containing data of the program A exceeds “5”, the broadcast data receiver 3 determines that the viewer has watched the program A.

(Process Flow)

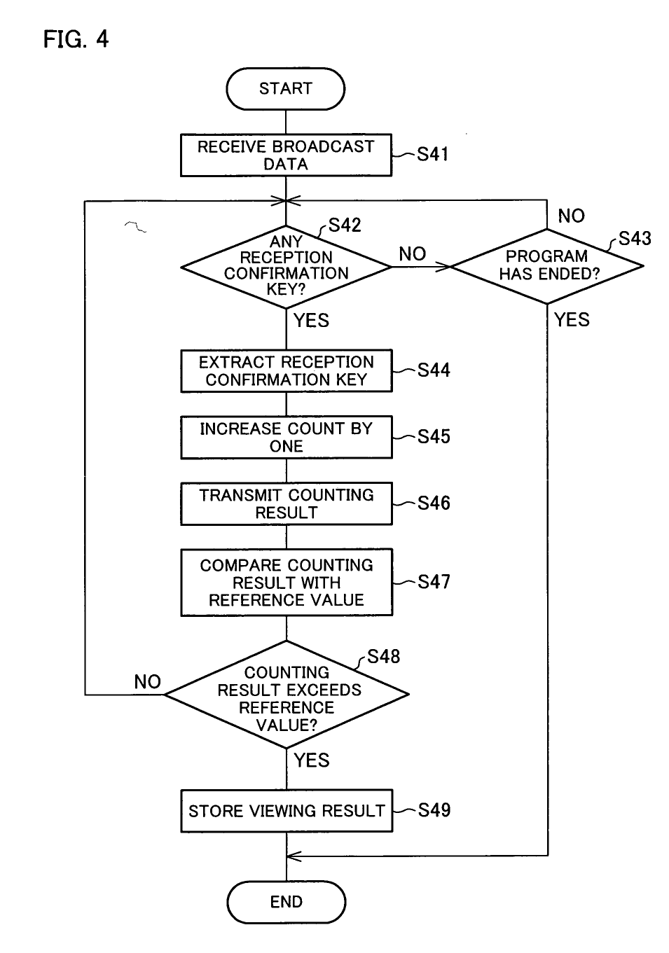

The following will describe a flow of the process performed by the broadcasting system 1 with reference to FIG. 4. FIG. 4 is a flowchart illustrating the flow of the process performed by the broadcasting system 1 according to First Embodiment.

The broadcast data transmitter 2 transmits the broadcast data 20 illustrated in FIG. 2 to the broadcast data receiver 3. In the broadcast data receiver 3, the broadcast data receiving section 5 receives the broadcast data 20 transmitted from the broadcast data transmitter 2 (Step S41). The broadcast data receiving section 5 supplies the received broadcast data 20 to the input processing section 10 and the reception confirmation key extracting section 8. The input processing section 10 causes the display device 11 to display thereon a program corresponding to the supplied program data 22, which is not particularly shown in the drawings.

The reception confirmation key extracting section 8 determines whether the supplied broadcast data 20 contains any reception confirmation keys 24 (Step S42). If having determined that the supplied broadcast data 20 contains no reception confirmation keys 24 (No), the reception confirmation key extracting section 8 determines whether the program has ended (Step S43). If the reception confirmation key extracting section 8 determines that the program has ended (Yes), the broadcasting system 1 terminates the process illustrated in FIG. 4. On the other hand, if the reception confirmation key extracting section 8 determines that the program has not ended yet (No), the process goes back to Step S42. Then, the reception confirmation key extracting section 8 determines again whether the broadcast data 20 contains any reception confirmation key 24.

On the other hand, in Step S42, if having determined that the broadcast data 20 contains the reception confirmation key 24 (Yes), the reception confirmation key extracting section 8 extracts the reception confirmation key 24 from the broadcast data 20 (Step S44). The reception confirmation key extracting section 8 notifies the extraction of the reception confirmation key 24 to the reception confirmation processing section 7. In response to the notification, the reception confirmation processing section 7 increase the count of the reception confirmation keys 24 by one (Step S45). The count of the reception confirmation keys 24 is stored in the memory 6.

Next, the reception confirmation processing section 7 transmits the count of the reception confirmation keys 24 to the viewing management server 4 (Step S46). In the viewing management server 4, the data communications section 13 receives the transmitted count. The data communications section 13 outputs the received count to the viewing determination section 14. Then, the viewing determination section 14 identifies a program identifier in some way. For example, assume that a program identifier is “A”. The viewing determination section 14 makes access to the viewing determination database 15 to obtain a reference value of the program A from the reference value management table 30.

The viewing determination section 14 compares the reference value having been obtained from the reference value management table 30 with the count having been supplied from the data communications section 13 (Step S47). Then, the viewing determination section 14 determines whether the count exceeds the reference value (Step S48).

In Step S48, if having determined that the count does not exceed the reference value (No), the viewing determination section 14 performs no particular operation. In this case, the broadcast data receiver 3 proceeds with the process in the steps subsequent to Step S42.

On the other hand, in Step S48, if the count exceeds the reference value (Yes), the viewing determination section 14 determines that the viewer has watched the program. Then, the viewing determination section 14 stores, into the viewing result database 16, data representing that the viewer has watched the program. In the present embodiment, the viewing determination section 14 stores this data into a viewing result table 50 that is provided in the viewing result database 16.

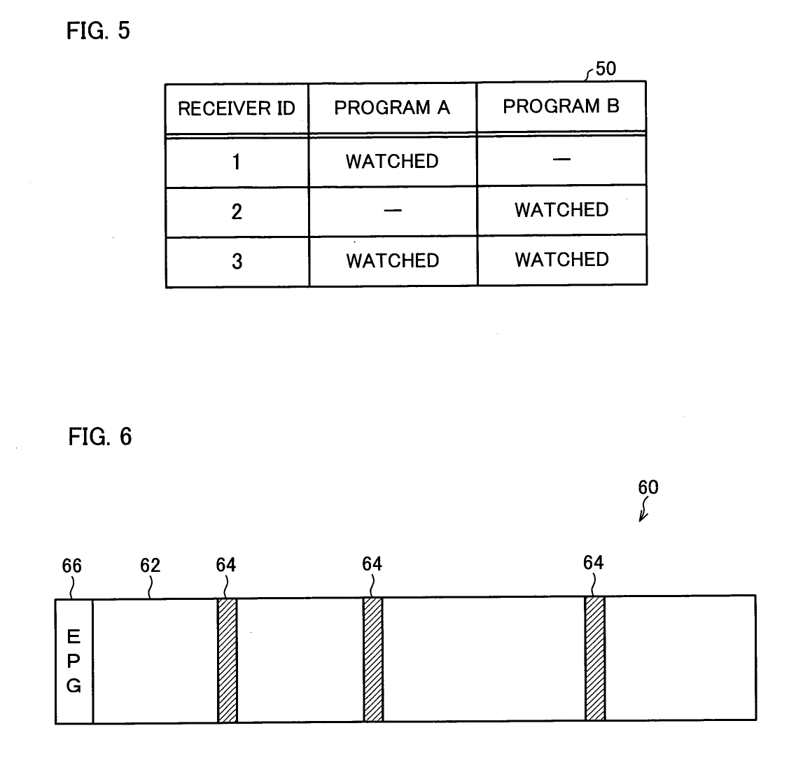

FIG. 5 is a view illustrating the structure of the viewing result table 50. The viewing result table 50, as illustrated in FIG. 5, stores an identifier (receiver ID) by which the broadcast data receiver 3 can be identified and a viewing result for each program. The identifier and the viewing result are associated with each other. For example, assume that the viewing determination section 14 determines that the viewer has watched a program A on the broadcast data receiver 3 with a receiver ID “1”. Then, the viewing determination section 14 stores, on the viewing result table 50, data “WATCHED” in a field for the receiver ID “1” and the program ID “A”.

In this manner, by using the viewing result table 50, the viewing determination section 14 manages whether the viewer has watched a program, for each program and for each broadcast data receiver 3.

As described above, even if the reception confirmation key extracting section 8 has extracted just one reception confirmation key 24, the viewing determination section 14 does not determine that the viewer has watched the program. Instead, when the number of the plurality of reception confirmation keys 24 having been extracted by the reception confirmation key extracting section 8 exceeds in number a predetermined reference value, the viewing determination section 14 determines that the viewer has watched the program.

That the reception confirmation key extracting section 8 extracts a plurality of reception confirmation keys 24 means that the broadcast data receiver 3 has continuously received the broadcast data 20 for a certain amount of time. There is therefore a high possibility that the viewer did not tune in to a channel corresponding to the program for a moment, but the viewer kept watching the program for a certain amount of time. In such a manner, the viewing determination section 14 can determine more accurately that the viewer has watched the program.

(Program Identification)

The viewing determination section 14 can identify what program the broadcast data receiver 3 is receiving in some way. The following is an example of the way of identifying the program: the viewing determination section 14 can identify the program that the broadcast data receiving section 5 is receiving, by using an Electronic Program Guide (EPG).

FIG. 6 is a view illustrating an example of the broadcast data 60 including EPG data combined. As illustrated in FIG. 6, the broadcast data 60 includes program data 62, a plurality of reception confirmation keys 64, and one EPG data 66. the reception confirmation keys 64 and the EPG data 66 are combined with the broadcast data 60. The EPG data 66 is data representing EPG. This EPG contains various sets of information for identifying a program.

The broadcast data receiving section 5 extracts the EPG data 66 from the received broadcast data 60. The broadcast data receiving section 5 stores the extracted EPG data 66 into the memory 6. With this, when having extracted the reception confirmation key 64, the reception confirmation key extracting section 8 obtains program information from the EPG data 66, which is stored in the memory 6. Subsequently, the reception confirmation processing section 7 transmits the count of the reception confirmation keys 64 to the viewing management server 4. Concurrently with this transmission, the reception confirmation processing section 7 transmits the obtained program information. In this manner, the viewing determination section 14 can identify the program in accordance with the program information, which has been transmitted from the broadcast data receiver 3.

The foregoing program identifying method is only an example. Alternatively, for example, the broadcast data receiver 3 may obtain the EPG data 66 via a communications network such as Internet.

(Serial-Numbered Reception Confirmation Keys)

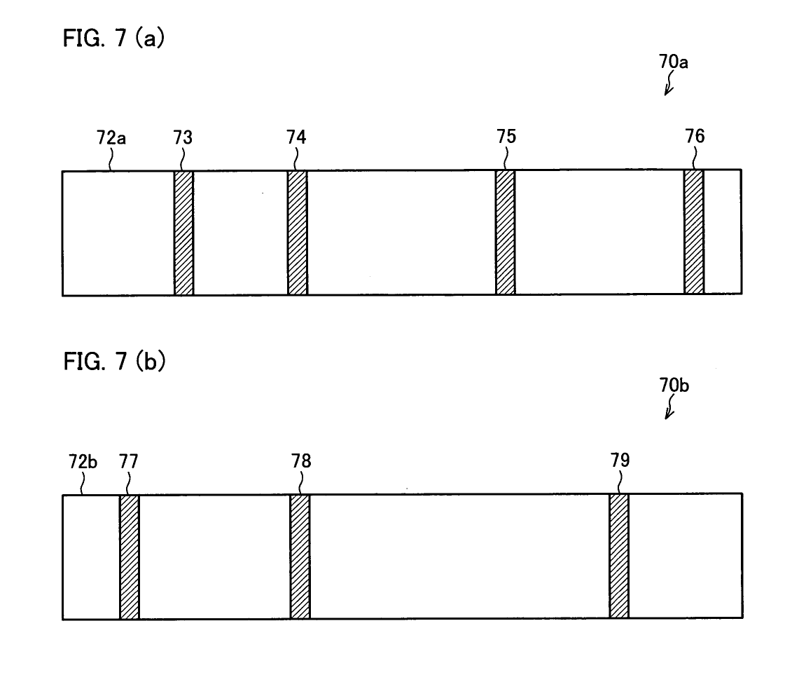

The broadcast data transmitter 2 can transmit broadcast data 70a and broadcast data 70b, which are illustrated respectively in FIGS. 7(a) and 7(b), to the broadcast data receiver 3. FIG. 7(a) is a view illustrating the structure of the broadcast data 70a including combined serial-numbered reception confirmation keys. FIG. 7(b) is a view illustrating the structure of the broadcast data 70b into which serial-numbered reception confirmation keys are combined.

As illustrated in FIG. 7(a), the broadcast data 70a includes program data 72a and reception confirmation keys 73, 74, and 75. The reception confirmation keys 73, 74, and 75 are combined with the program data 72a. Meanwhile, as illustrated in FIG. 7(b), the broadcast data 70b includes program data 72b and reception confirmation keys 77, 78, and 79. The reception confirmation keys 77, 78, and 79 are combined with the program data 72b.

The reception confirmation keys 73 through 79 are serial-numbered. For example, the reception confirmation key 73 has a reception confirmation key ID “1”. Meanwhile, the reception confirmation key 74 has a reception confirmation key ID “2”.

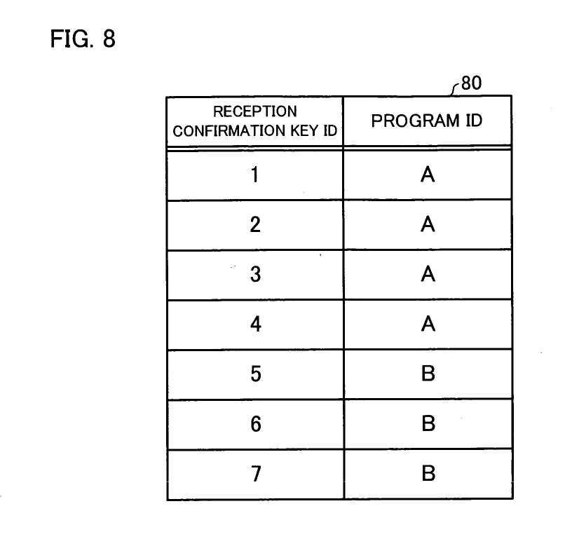

Here, by using a program management table 80 illustrated in FIG. 8, the viewing determination section 14 identifies what program the program data into which reception confirmation keys are combined is about. FIG. 8 is a view illustrating the structure of the program management table 80. The program management table 80 is stored in the viewing determination database 15 of the viewing management server 4. As illustrated in FIG. 8, the program management table 80 stores therein a reception confirmation key ID and a program ID. The reception confirmation key ID and the program ID are associated with each other.

In the program management table 80, the program ID is “A” for the reception confirmation key ID “1”. Thus, by using the program management table 80, the viewing determination section 14 determines that the reception confirmation key 73 having the reception confirmation key ID “1” is combined with the program data 70 representing the program A. That is, the viewing determination section 14 determines that the reception confirmation key 73 is a reception confirmation key regarding the program A. Similarly, the viewing determination section 14 determines that the reception confirmation keys 74 through 76 are keys regarding the program A. Meanwhile, the viewing determination section 14 determines that the reception confirmation keys 77 through 79 are reception confirmation keys regarding the program B.

As described above, the viewing determination section 14 can identify a program corresponding to a reception confirmation key by various methods, even if the program identifiable information is not contained in advance in the reception confirmation key. The foregoing program identifying method is only an example. The viewing determination section 14 can identify a program corresponding to a reception confirmation key by every conceivable methods.

(Another Structure of the Broadcasting System 1)

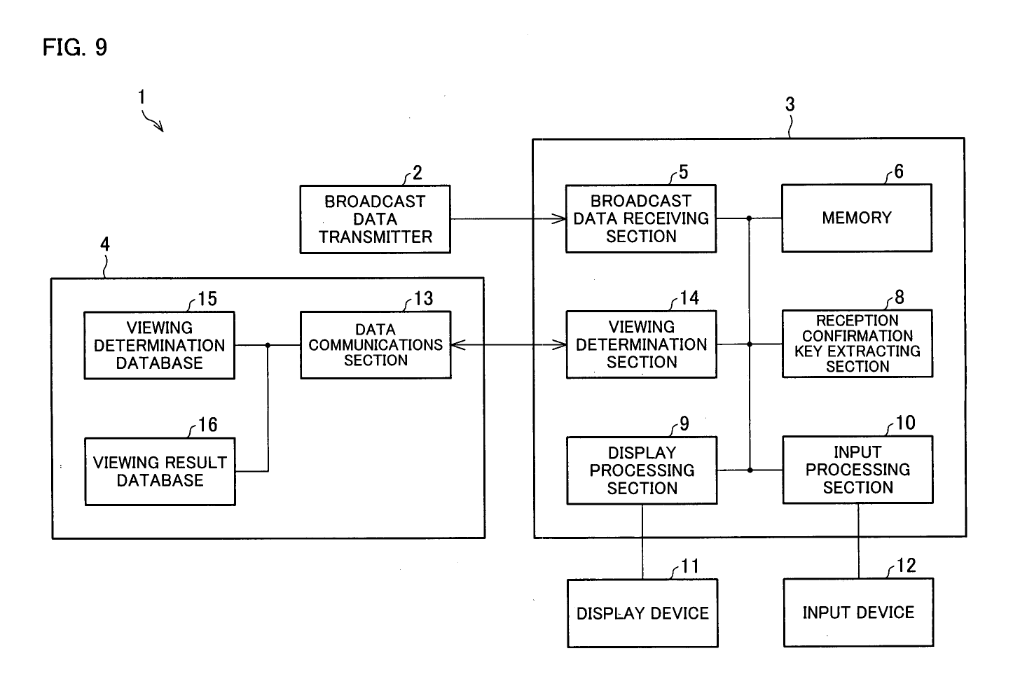

In the broadcasting system 1, the viewing determination section 14 is not necessarily included in the viewing management server 4. That is, the broadcasting system 1 can be realized with the structure illustrated in FIG. 9. FIG. 9 is a block diagram of the broadcasting system 1 where the viewing determination section 14 is provided in the broadcast data receiver 3.

In the broadcasting system 1 illustrated in FIG. 9, the viewing determination section 14 is provided in the broadcast data receiver 3 rather than in the viewing management server 4. That is, whether the viewer has watched a program is determined by the broadcast data receiver 3, not by the viewing management server 4.

In such an arrangement, the viewing management server 4 offers in advance the broadcast data receiver 3 a reference value from which whether a program has been watched can be determined. Specifically, in the viewing management server 4, the data communications section 13 reads out the reference value management table 30 itself from the viewing determination database 15. Then, the data communications section 13 transmits the read reference value management table 30 to the broadcast data receiver 3.

In the broadcast data receiver 3, the viewing determination section 14 receives the reference value management table 30 transmitted from the data communications section 13. The viewing determination section 14 stores the reference value management table 30 into the memory 6.

Then, in the broadcast data receiver 3, the reception confirmation key extracting section 8 extracts reception confirmation keys from broadcast data and then supplies the extracted reception confirmation keys to the viewing determination section 14. The viewing determination section 14 counts the reception confirmation keys supplied. Next, the viewing determination section 14 reads out a reference value of a corresponding program from the reference value management table 30 stored in the memory 6. If the count of the reception confirmation keys exceeds the reference value, the viewing determination section 14 determines that the viewer has watched the program. Then, the viewing determination section 14 transmits, to the viewing management server 4, a program identifier, an identifier of the broadcast data receiver 3, and information indicating that the viewer has watched the program.

In the viewing management server 4, the data communications section 13 receives the notification from the viewing determination section 14. Then, the data communications section 13 makes access to the viewing result database 16, and stores data “WATCHED” in a field for the concerned receiver ID. The data “WATCHED” indicates that the viewer has watched the program. That is, the data communications section 13 stores the viewer's viewing result of the program into the viewing result table 50.

Note that the broadcasting system 1 illustrated in FIG. 9 is only an example. In other words, the broadcasting system 1 configurable as the present invention is not limited to the system illustrated in FIG. 9. The broadcasting system 1 may be any system, provided that the viewing determination section 14 provided in any device can determine as appropriate that the viewer has watched a program.

### Second Embodiment

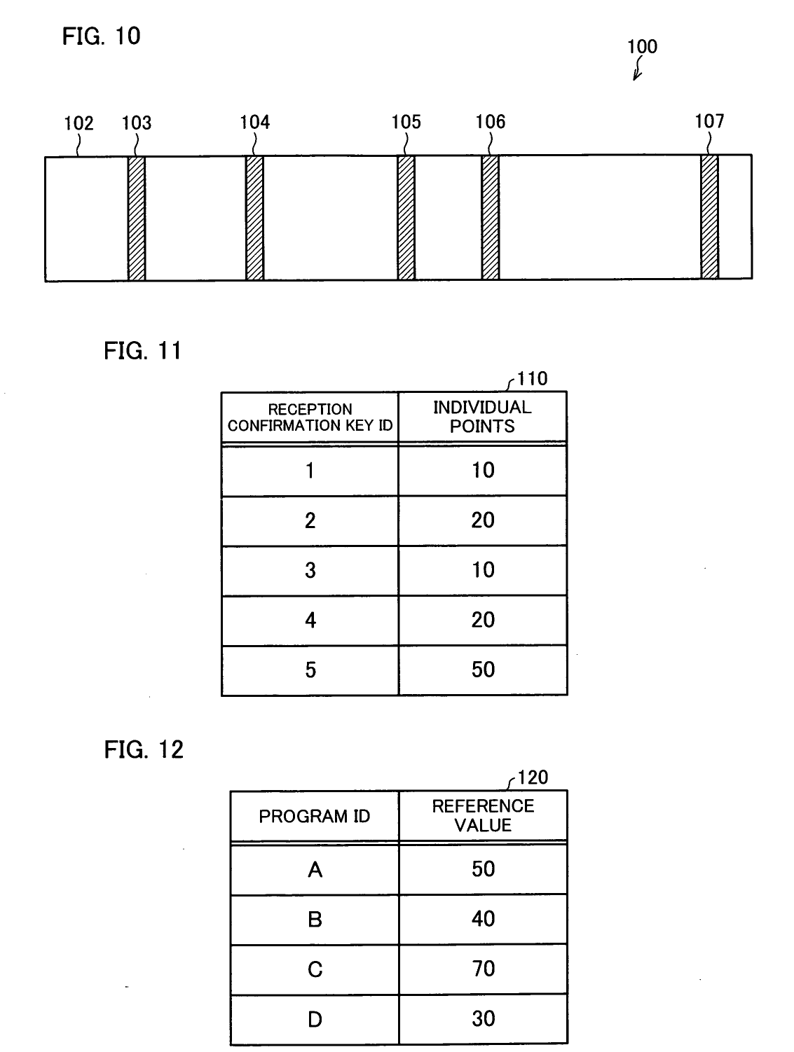

The following will describe an embodiment according to the present invention with reference to FIGS. 10 through 14.

FIG. 10 is a view illustrating the structure of broadcast data 100 containing combined reception confirmation keys. Each of the reception confirmation keys includes an identifier by which a reception confirmation key can be identified. In the broadcast data 100, reception confirmation keys 103 through 107 are combined with program data 102. Each of the reception confirmation keys 103 through 107 contains the identifier that identifies the reception confirmation key uniquely, i.e. a reception confirmation key ID. In the viewing management server 4, the viewing determination section 14 can individually identify reception confirmation keys having been transmitted from the broadcast data receiver 3.

In the present embodiment, the viewing determination section 14 uses a point management table 110 illustrated in FIG. 11 and a reference value management table 120 illustrated in FIG. 12. The tables are described below. FIG. 11 is a view illustrating the point management table 110. As illustrated in FIG. 11, the point management table 110 stores the reception confirmation key ID and an individual point, both of which are associated with each other. For example, a reception confirmation key ID “1” has an individual point of 10 points. A reception confirmation key ID “2” has an individual point of 20 points.

The viewing determination section 14 reads out, from the point management table 110, the individual point corresponding to the supplied reception confirmation key ID. The read individual point is added to the sum of previously calculated points. In such a manner, a reception score that the broadcast data receiver 3 has acquired can be calculated regarding the program of the broadcast data 100 received by the broadcast data receiver 3. The viewing determination section 14 compares the thus calculated reception score with the reference value read out from the reference value management table 120.

(Process Flow)

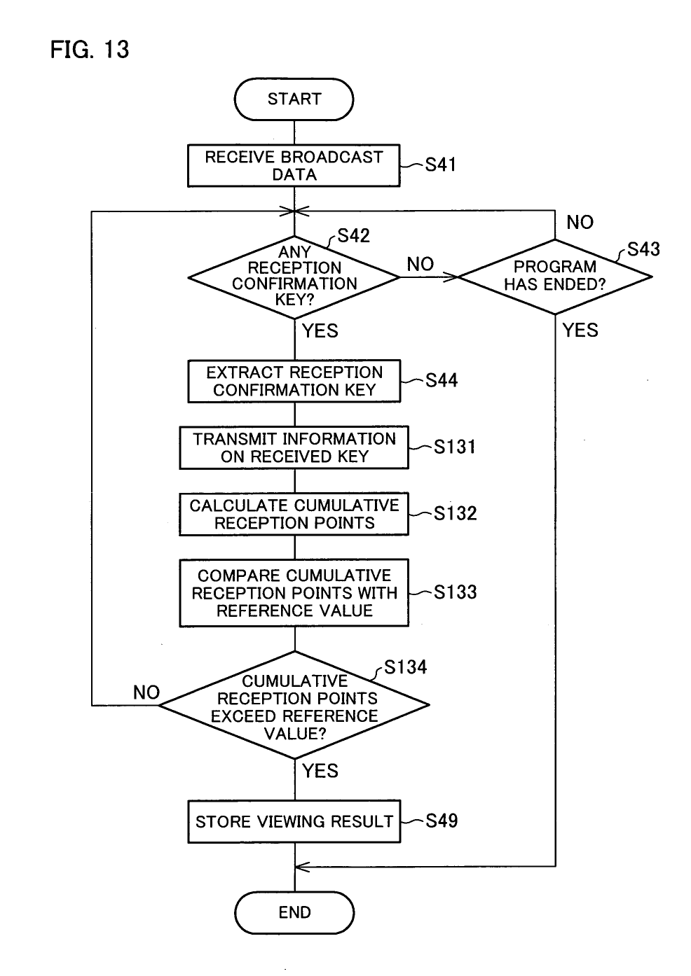

The following will describe the process performed by the broadcasting system 1 according to the present embodiment with reference to FIG. 13. FIG. 13 is a flowchart illustrating the flow of the process performed by the broadcasting system 1 according to Second Embodiment. Steps S41 through S44 and Step S49 in FIG. 13 are substantially the same as their corresponding steps illustrated in FIG. 4, and explanation thereof will be omitted.

In Step S131, the reception confirmation processing section 7 transmits information regarding the supplied reception confirmation key to the viewing management server 4 (Step S131). In transmitting the above information, the reception confirmation processing section 7 may directly transmit the supplied reception confirmation key itself, or may transmit the reception confirmation key ID contained in the reception confirmation key. In either case, the reception confirmation processing section 7 can transmit at least sufficient information to identify the reception confirmation key to the viewing management server 4.

In the viewing management server 4, the data communications section 13 receives the information regarding the reception confirmation key, which has been transmitted from the reception confirmation processing section 7. The data communications section 13 supplied the received information to the viewing determination section 14. From the supplied reception confirmation key, the viewing determination section 14 extracts the identifier of the reception confirmation key, i.e. the reception confirmation key ID. Then, the viewing determination section 14 makes access to the viewing determination database 15 to read out individual point from the reference value management table 120. The individual point is associated with the extracted reception confirmation key ID. For example, in case of the reception confirmation key ID “1”, the point “10” is read out, as illustrated in FIG. 11.

The viewing determination section 14 adds the read individual point to already-calculated cumulative points. In this manner, the viewing determination section 14 calculates the cumulative total reception points obtained by the broadcast data receiver 3 (Step S132).

The viewing determination section 14 compares the calculated cumulative total reception points with a predetermined reference value (Step S133). In this comparison, the viewing determination section 14 makes access to the viewing determination database 15 to read out the reference value stored in the reference value management table 120. The reference value is associated with the supplied program ID. For example, a reference value “50” is read out for the supplied program ID “A”. This allows the viewing determination section 14 to compare the reference value having been read out from the reference value management table 120 with the calculated cumulative total reception points. From a result of the comparison, the viewing determination section 14 determines whether the cumulative total reception points exceed the reference value (Step S134).

In Step S134, if the cumulative total reception points exceed the reference value (Yes), the viewing determination section 14 determines that the viewer has watched the program on the broadcast data receiver 3. Then, the viewing determination section 14 makes access to the viewing result database 16 to store the viewing result into the viewing result table 50 (Step S49). The method of storing the viewing result is the same as the method in First Embodiment, and explanation thereof is omitted.

On the other hand, in Step S134, if it is determined that the cumulative total reception points are below the reference value (No), the viewing determination section 14 determines that the viewer has not yet watched the program. Then, the process illustrated in FIG. 13 goes back to Step S42.

With the following process, the viewing determination section 14 can determine whether the viewer has watched a program more accurately.

(Essential Reception Confirmation Key to be Received)

The viewing determination section 14 may determine that the viewer has watched a program on the broadcast data receiver 3, if the broadcast data receiver 3 receives at least one predetermined essential key among the reception confirmation keys combined in the broadcast data 100, and if it is determined that cumulative total reception points calculated from a plurality of reception confirmation keys having received from the broadcast data receiver 3 exceed a predetermined reference value.

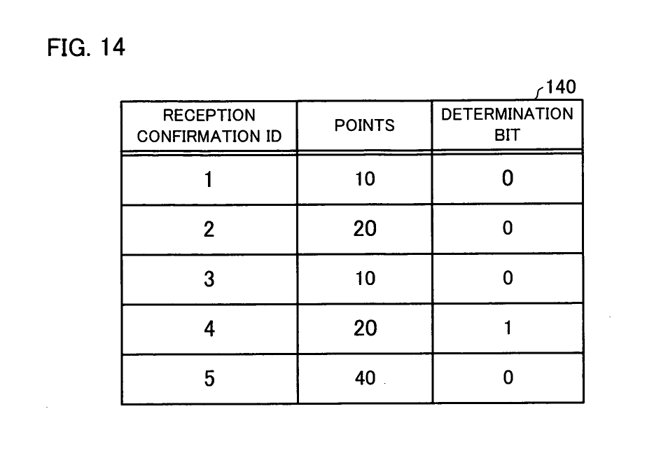

In this case, in the broadcasting system 1, whether or not it is determined in advance that whether each of the reception confirmation keys is determined in advance as to whether the reception confirmation key is essential to be received. More specifically, the viewing determination section 14 uses a point management table 140 illustrated in FIG. 14. FIG. 14 illustrates the point management table 140.

The point management table 140 stores in advance a value of a determination bit for each reception confirmation key ID. The determination bit indicates whether its corresponding reception confirmation key is essential to be received. A determination bit “1” means that its corresponding reception confirmation key is essential to be received.

For example, the determination bit is “0” for a reception confirmation key ID “1”. The viewing determination section 14 therefore determines that the reception confirmation key that is essential to be received has not yet been received, even though the broadcast data receiving section 5 has received the reception confirmation key whose ID is “1”.

Here, assume that the broadcast data receiver 3 has received four reception confirmation keys whose reception confirmation key IDs are 1, 2, 3, and 5, respectively. In this case, the viewing determination section 14 calculates 70 points as the reception points of the broadcast data receiver 3 by 10+20+10+40=70. The reception points thus calculated exceed “50” that is a viewing reference value of the program A. However, the broadcast data receiver 3 has not yet received the reception confirmation key having an ID “4” and a determination bit “1”. From this, the viewing determination section 14 determines that the viewer has not watched the program on the broadcast data receiver 3.

Here, the reception confirmation key whose determination bit is “1” is set at an important scene of a program.

### Third Embodiment

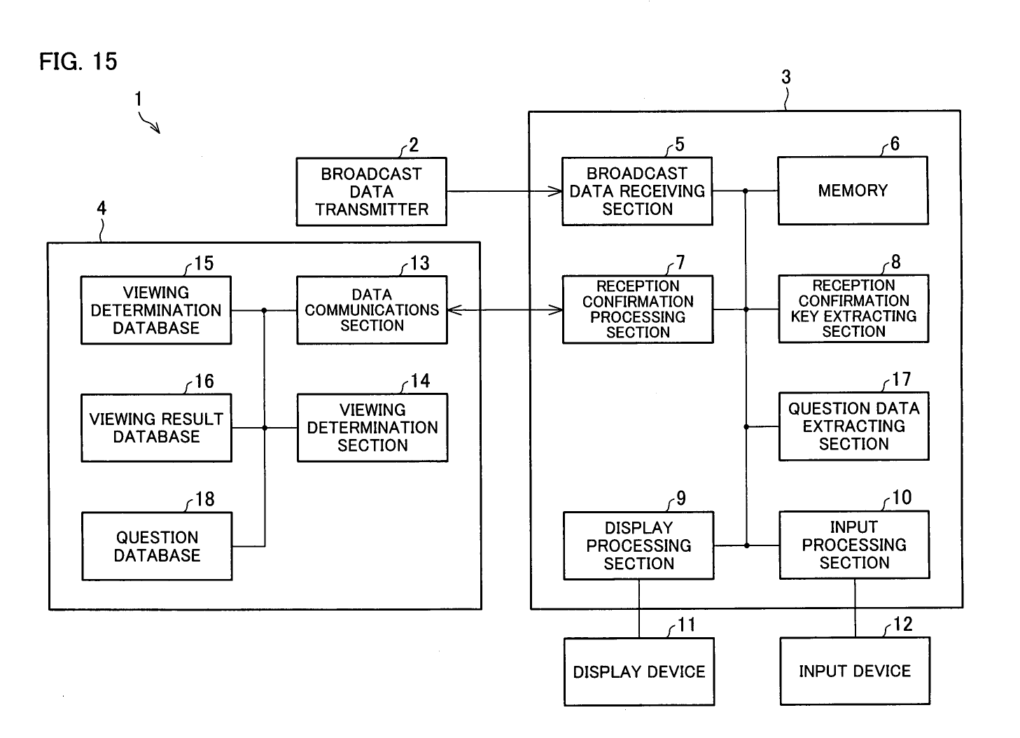

The following will describe Third Embodiment according to the present invention with reference to FIGS. 15 through 22. Note that, explanations of the members that have been already explained in First and Second Embodiments are omitted.

First of all, a broadcasting system 1 according to the present embodiment will be described with reference FIG. 15. FIG. 15 is a block diagram illustrating main components of the broadcasting system 1 according to Third Embodiment. In the broadcasting system 1 illustrated in FIG. 15, the broadcast data receiver 3 further includes a question data extracting section 17, in addition to the components illustrated in FIG. 1. The viewing management server 4 further includes a question database 18, in addition to the components illustrated in FIG. 1. The question data extracting section 17 and the question database 18 will be described later.

(Broadcast Data 160)

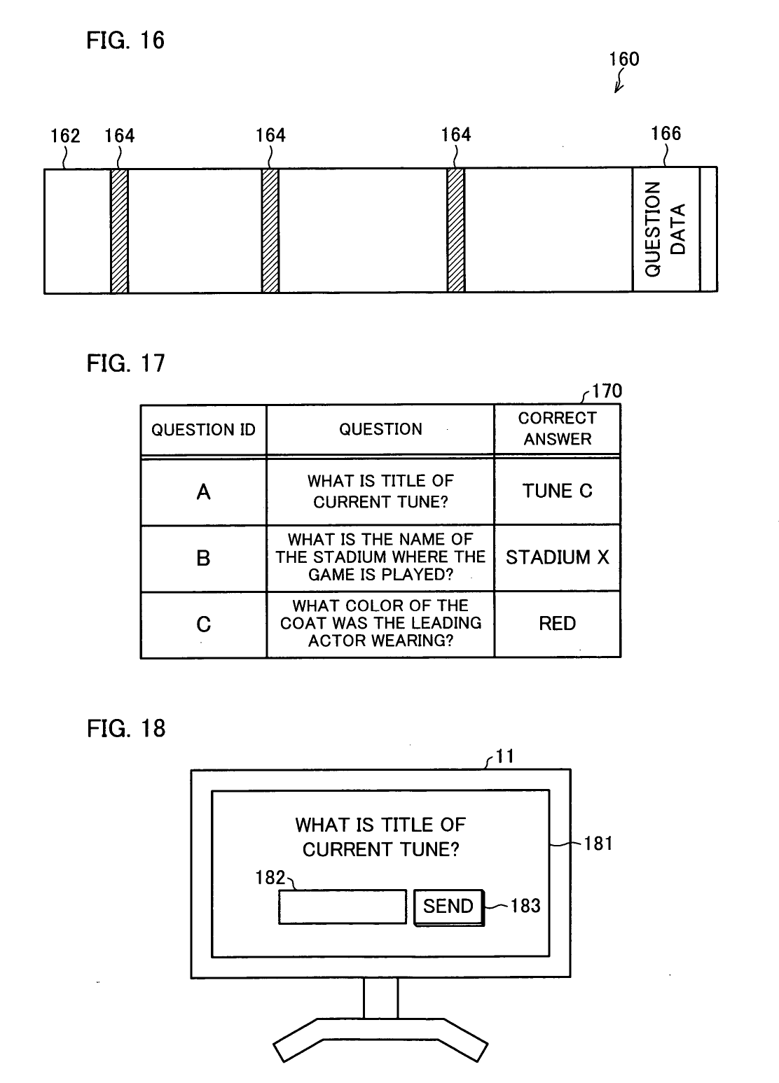

In the present embodiment, the broadcast data transmitter 2 transmits broadcast data 160 illustrated in FIG. 16 to the broadcast data receiver 3, by way of example. The following will describe the broadcast data 160. FIG. 16 is a view illustrating the broadcast data 160 including one question data 166 combined in advance.

As illustrated in FIG. 16, the broadcast data 160 includes program data 162, a plurality of reception confirmation keys, and one question data 166. The reception confirmation keys and the question data 166 are combined with the program data 162. The broadcast data transmitter 2 transmits the broadcast data 160 having such a structure to the broadcast data receiver 3.

In the broadcast data receiver 3, the question data extracting section 17 extracts the question data 166 from the broadcast data 160 and then supplies the extracted question data 166 to the display processing section 9. The display processing section 9 causes a question represented as the supplied question data 166 to be displayed on a display device 11. This question relates to a program being received by the broadcast data receiver 3. A viewer having recognized the question displayed on the display device 11 enters his/her answer by means of an input device 12. The broadcast data receiver 3 transmits the entered answer to the viewing management server 4.

(Question Management Table 170)

In the present embodiment, the viewing determination section 14 determines from a question management table 170 whether the viewer's answer is correct. The question management table 170 is provided in a question database 18 of the viewing management server 4.

FIG. 17 is a view illustrating the structure of the question management table 170. As illustrated in FIG. 17, the question management table 170 stores a question ID, question data, and correct-answer data, which are associated with one another.

The question ID is an identifier for identifying a question. The question ID is contained in advance in the question data 166 of the broadcast data 160. The question data is data representing a question presented to the viewer. The correct-answer data is data representing a correct answer to the corresponding question. As illustrated in FIG. 17, the question management table 170 stores, for example, a question ID “A” and question data “What is the title of the current tune?”, and correct-answer data “Tune C”, all of which are associated with one another.

(Example of Question Displayed)

The broadcast data receiver 3 causes the question indicated by the question data 166 to display on the display device 11. For example, as illustrated in FIG. 18, the question “What is the title of the current tune?” is displayed on a display screen 181 of the display device 11. The viewer having stored this display enters his/her answer in an answer section 182. After having entered the answer, the viewer pushes down a transmission button 183. Then, the broadcast data receiver 3 transmits the entered answer data to the viewing management server 4.

(Process Flow)

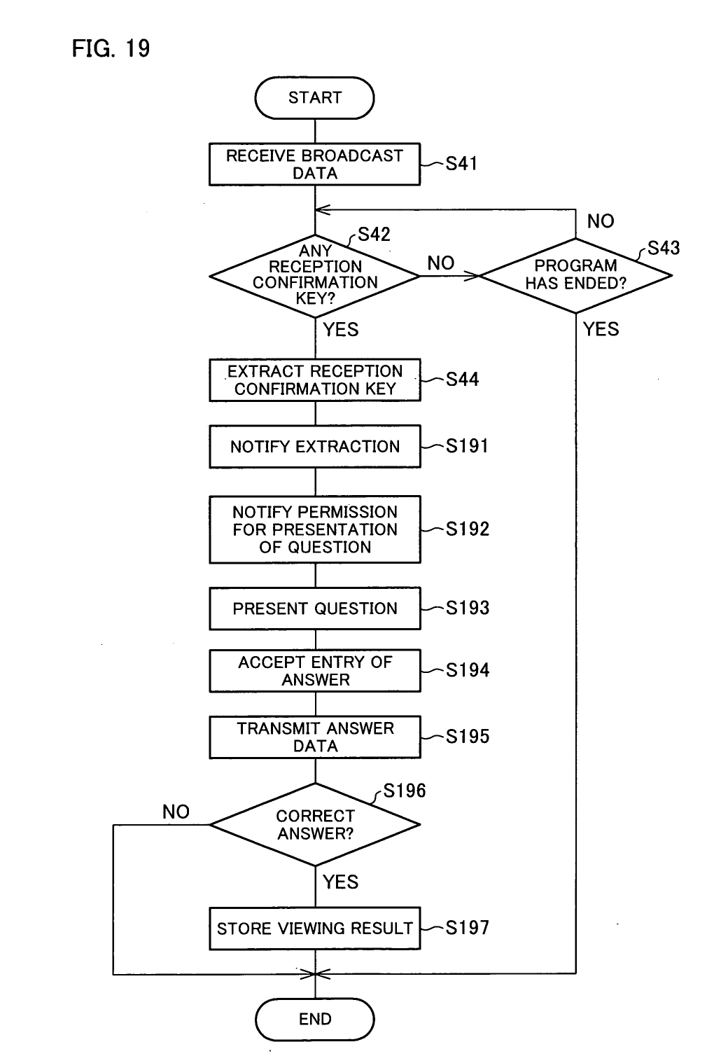

The following will describe the flow of a process performed in the broadcasting system 1 of the present embodiment with reference to FIG. 19. FIG. 19 is a flowchart illustrating the flow of the process performed in the broadcasting system 1 according to Third Embodiment. In FIG. 19, Steps S41 through S43 are the same as their corresponding steps illustrated in FIG. 4, and explanations thereof will be omitted.

The reception confirmation key extracting section 8 extracts a reception confirmation key 164 from the broadcast data 160 (Step S44). Then, the reception confirmation processing section 7 notifies to the viewing management server 4 that the reception confirmation key extracting section 8 has extracted the reception confirmation key (Step S191).

In the viewing management server 4, the viewing determination section 14 determines, from the notification from the reception confirmation processing section 7, that the broadcast data receiver 3 has received at least one reception confirmation key. From this, the viewing determination section 14 determines permission for the presentation of the question about the program to the viewer. At this point, the viewing determination section 14 has not yet determined that the viewer has watched the program.

The viewing determination section 14 notifies to the broadcast data receiver 3 that it permits the broadcast data receiver 3 to present the question (Step S192). In the broadcast data receiver 3, the reception confirmation processing section 7 having received such a notification supplies the permission for the presentation of a question to the question data extracting section 17. Then, when the question data extracting section 17 confirm that the question data 166 is combined with the broadcast data 162, the question data extracting section 17 extract the question data 166 from the broadcast data 160. The question data extracting section 17 supplies the extracted question data 166 to the display processing section 9. Further, the question data extracting section 17 supplied the question ID contained in the question data 166 to the reception confirmation processing section 7.

The display processing section 9 causes the question indicated by the supplied question data 166 to be displayed on the display device 11. The viewer having recognized the displayed question enters an answer by means of the input device 12. The entry of this answer is accepted by the input processing section 10 (Step S194). Then, the input processing section 10 generates answer data indicating the accepted answer. The input processing section 10 supplies the generated answer data to the reception confirmation processing section 7. The reception confirmation processing section 7 transmits the supplied answer data together with the question ID to the viewing management server 4 (Step S195).

In the viewing management server 4, the data communications section 13 receives the answer data and question data having been transmitted from the reception confirmation processing section 7. The data communications section 13 supplies the received answer data and question ID to the viewing determination section 14. The viewing determination section 14 makes access to the question database 18, and obtains right-answer data from the question management table 170 in which the right-answer data is associated with the supplied question ID. Then, the viewing determination section 14 compares the right-answer data obtained from the question management table 170 with the supplied answer data. From a result of the comparison, the viewing determination section 14 determines whether the answer having been supplied by the viewer to the broadcast data receiver 3 is correct (Step S196).

In Step S196, if the viewing determination section 14 determines that the answer is correct (Yes), the viewing determination section 14 determines that the viewer has watched the program. Then, the viewing determination section 14 make access to the viewing result database 16 to store the viewing result of the viewer into the viewing result table 50. For example, when it is determined that the viewer has watched the program A on the broadcast data receiver 3 having a receiver ID “1”, data “WATCHED” is stored in a field for the receiver ID “1” and the program ID “A” in the viewing table 50.

Through the foregoing process, the viewing determination section 14 determines that the viewer has watched the program if the viewer on the broadcast data receiver 3 has had a correct answer to a question about the program displayed on the display device 11. Thus, it is possible to more accurately determine whether the viewer has watched a program.

Note that the question data 166 is not necessarily combined with the program data 162. In such an arrangement, the broadcast data receiver 3 obtains in advance question data representing a question about the program through the Internet or other communications line and stores the obtained question data into a predetermined database.

The broadcast data transmitter 2 transmits, to the broadcast data receiver 3, the broadcast data 160 including a question presentation instruction key combined in advance. The question presentation instruction key is a key instructing the presentation of the question. After the broadcast data receiving section 5 receives the question presentation instruction key, the display processing section 9 obtains the question data from the above database and then causes the question represented as the question data to display on the display device 11.

That is, the display processing section 9 can present a question to the viewer at a reception timing of the question presentation instruction key. This allows the broadcast receiving device to reliably present the question to the viewer at an appropriate timing even in the arrangement where the question data is not combined with program data in advance.

(Addition of Viewing Points)

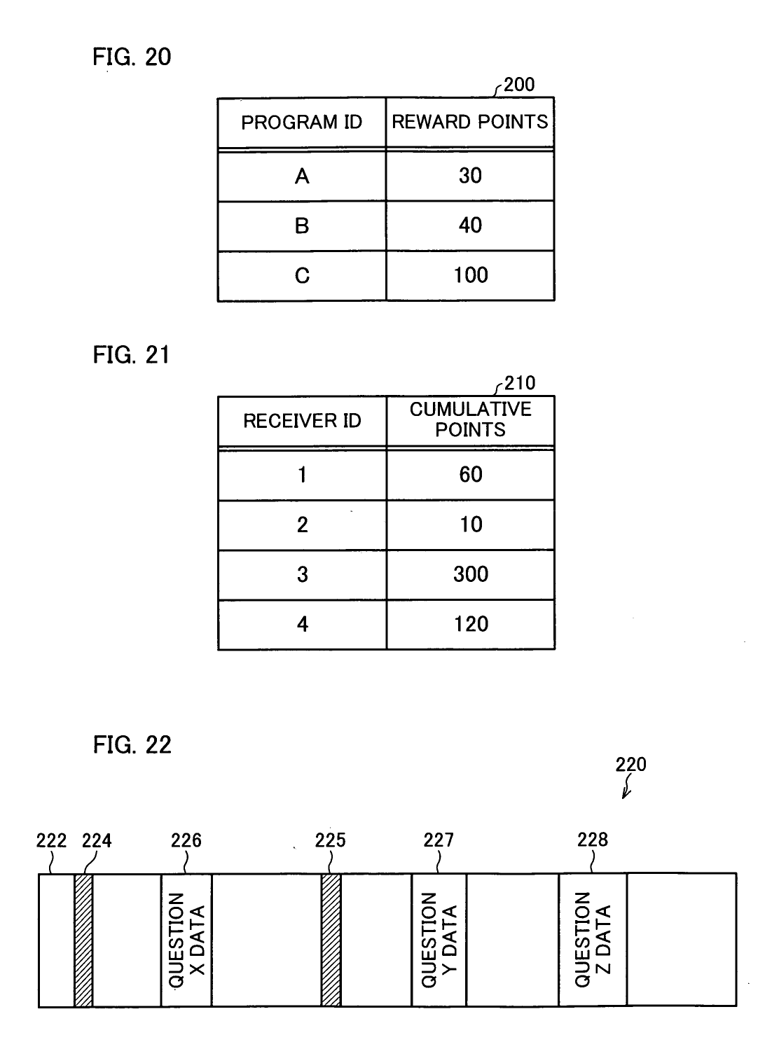

In the present embodiment, the viewing determination section 14 can give an incentive to a viewer (properly speaking, to the broadcast data receiver 3) when the viewing determination section 14 determines that the viewer has watched a program. Specifically, the viewing determination section 14 manages incentives to be given to the viewers by using a reward point management table 200 illustrated in FIG. 20 and a cumulative point management table 210 illustrated in FIG. 21.

Note that in the viewing management server 4, the reward point management table 200 is provided in advance in the viewing determination database 15. The cumulative point management table 210 is provided in advance in the viewing result database 16.

(Reward Point Management Table 200)

The following will describe an example of the reward point management table 200 with reference to FIG. 20. FIG. 20 is a view illustrating an example of the reward point management table 200. As illustrated in FIG. 20, the reward point management table 200 stores a program ID and reward points, both of which are associated with each other.

When the viewing determination section 14 determines that the viewer has watched a program, the viewing determination section 14 makes access to the viewing determination database 15. Thus, the viewing determination section 14 obtains, from the reward point management table 200, reward points corresponding to a supplied program ID.

FIG. 21 is a view illustrating the structure of the cumulative point management table 210. As illustrated in FIG. 21, the cumulative point management table 210 stores a receiver ID and cumulative points, both of which are associated with each other. The viewing determination section 14 makes access to the viewing result database 16. Then, the viewing determination section 14 reads out cumulative points corresponding to a supplied receiver ID, from the cumulative point management table 210. Further, the viewing determination section 14 adds the reward points having been read from the reward point management table 200 to the cumulative points having been read from the cumulative point management table 210. In this manner, new cumulative points of the broadcast data receiver 3 can be calculated.

Then, the viewing determination section 14 stores the new cumulative points thus calculated into the cumulative point management table 210 after having designated the corresponding receiver ID. In other words, through the foregoing process, cumulative points are updated for each receiver ID.

(Summary of the Point Addition)

As described above, the broadcast data receiver 3 gives points to a viewer when both conditions 1 and 2 are satisfied. The conditions 1 and 2 are as follows:

Condition 1: The reception confirmation key extracting section 8 extracts a reception confirmation key from the broadcast data 220.

Condition 2: A viewer's answer is correct.

Assume that the viewer turns on the broadcast data receiver 3, and leaves the display device 11 on so as to just display the program thereon. In other words, the viewer's intent is to improperly obtain points without watching the program. However, such a case satisfies the condition 1, but does not satisfy the condition 2. This is because the viewer does not answer the question.

This avoids the viewing determination section 14 from giving unnecessary points to the viewer who leaves the display device 11 on to just display the program thereon. That is, it is possible to reliably prevent viewing points from being improperly given to the viewer.

The broadcast data receiver 3 may be arranged so as not to present the question to the viewer until the condition 1 is satisfied. That is, the broadcast data receiver 3 does not need to present the question in the situation where the condition 1 is not satisfied. In such an arrangement, the viewer can concentrate on watching the program. In other words, it is possible to avoid needless confusion for the viewer. Moreover, the broadcast data receiver 3 can eliminate an act of the viewer, such as just answering the question without watching the program.

In the broadcast data receiver 3, when the condition 1 is not satisfied, i.e. when in the situation where the broadcast data receiver 3 has received the program, but has not yet received the reception conformation key, the display processing section 9 (informing means) may inform to the viewer information regarding incentives offered to the viewer. More specifically, the display processing section 9 causes the display device 11 to display messages thereon. The messages include that the question is displayed on the display device 11 if the viewer has kept watching the program for a certain amount of time period, and that if the viewer answers the displayed question correctly, a given number of viewing points are given to the viewer. This drives the viewer to keep watching the program at the aim of gaining such an incentive. This allows the broadcast data receiver 3 to improve a program rating.

Further, the display processing section 9 may present the question about the program to the viewer, when the viewing determination section 14 has determined that the viewer has watched the program. In such an arrangement, when the viewer has answered the question correctly, the viewing determination section 14 offers an incentive to the viewer. For example, the viewing determination section 14 offers the viewer a right to view a pay program for free, or reduces a charge for program viewing according to the number of programs that the viewer has watched.

With this arrangement, the broadcast data receiver 3 motivates the viewer to become more eager to watching the program, thus resulting in improvement of a program rating. If it is impossible to determine that the viewer has watched the program, the broadcast data receiver 3 does not present the question to the viewer. Thus, it is possible to prevent a viewer's act to obtain an incentive improperly.

The display processing section 9 may inform the viewer of information regarding an incentive, when the viewing determination section 14 has determined that the viewer has not yet watched the program. For example, the information includes (a) doing a quiz if the viewer has watched the program for a certain amount of time period and (b) offering a certain incentive if the viewer answers the quiz correctly. This drives the viewer to keep watching the program at the aim of gaining such an incentive. In addition, this drives the viewer to work hard to answer the presented quiz correctly. This allows the broadcast data receiver 3 to improve a program rating.

(Method of Adding Points)

An example of the points that the viewer can obtain when he/she has watched a program is not limited to the foregoing example. Alternatively, for example, the viewing determination section 14 may add more points to cumulative points when the viewer has watched a new program, compared to points to be added when the viewer has watched the existing program. The more points are given, the higher the possibility that the viewer might view the program. Thus, the viewing management server 4 can obtain a higher audience rating for the new program.

(Additional Service Offered)

The broadcast data receiver 3 may optionally offer an additional service to a viewer by using cumulative points managed for each receiver ID. This additional service is performed to increase an audience rating for a program broadcasted from a broadcast station.

For example, the viewing management server 4 can instructs the broadcast data transmitter 2 to transmit a pay program with no charge to the broadcast data receiver 3 whose cumulative points have exceeded a particular number of points. This attracts the viewer to more actively watching such a program with the aim of watching a pay program for free. This allows the viewing management server 4 to obtain a much higher audience rating for the program that is broadcasted from a broadcast station using the broadcast data transmitter 2.

If an audience rating for a program becomes higher, the value of an advertisement which is broadcasted with the program by the broadcast station becomes higher correspondingly. This is because the more people watch the program, the more people watch the advertisement. This allows a sponsor of the advertisement to obtain higher advertisement effects by broadcasting the advertisement. Meanwhile, the broadcast station can obtain a higher advertisement rate from the sponsor of the advertisement.

When the viewing determination section 14 determines that the viewer has watched entire series of programs that continue to be broadcasted periodically, the viewing determination section 14 may give special service viewing points. This motivates the viewer to watch entire series of programs, thus increasing an audience rating for each of the programs.

(Inviting to Own Website of a Broadcaster)

Assume that a broadcast station of a broadcaster using the broadcast data transmitter 2 operates a website of the program broadcasted from that broadcast station. Under such a situation, the viewing management server 4 may offer a particular service from the website of the broadcaster in accordance with the cumulative points remained. For example, the broadcast station prepares a particular web page in its own website. Access to the web page is not gained without input of a password. The viewing management server 4 notifies the password to the broadcast data receiver 3 whose cumulative points have exceeded reference points. By using the obtained password, the viewer can make access to the particular web page, which has been prepared by the broadcast station.

With the above arrangement, the viewer becomes more eager to watch the program with the aim of gaining access to the special web page provided by the broadcast station. This allows the broadcasting system 1 to obtain a much higher audience rating for the program.

Thus, the broadcasting system 1 according to the present embodiment can provide a high added value for all concerned in the broadcasting system 1, i.e. the viewer, the broadcast station, and the sponsor.

(Other Uses of the Viewing Points)

Further, the broadcast station can offer the foregoing points as a right for the viewer to purchase goods in a shopping program broadcasted by the broadcast station. Still further, the broadcast station can offer the foregoing points as a right for the viewer to purchase clothes that an actor is wearing in a drama. Yet further, the broadcast station can offer the foregoing points as a right for the viewer to view a pay program at a reduced price. That is, the broadcast station can use the points for each receiver ID, accumulated in the viewing management server 4, as a means for increasing a program rating.

(A Plurality of Questions)

The number of question data combined with the broadcast data is not limited to one. The question data may be two or more. The broadcast data transmitter 2 can transmit, to the broadcast data receiver 3, the broadcast data containing plural sets of question data combined. This example will be described below with reference to FIG. 22.

FIG. 22 is a view illustrating broadcast data 220 including plural sets of question data combined in advance. As illustrated in FIG. 22, in the broadcast data 220, reception confirmation keys 224 and 245 are combined with program data 222 in advance. Further, three question data, i.e. question X data 226, question Y data 227, and question Z data 228 are also combined with the program data 222.

The question X data 226 indicates a question X. The question Y data 227 indicates a question Y. The question Z data 228 indicates a question Z. The questions X, Y, and Z are related to a program that the program data 222 describes, and are mutually different questions.

When the broadcast data receiver 3 receives the broadcast data 220, the question data extracting section 17 extracts the question X data 226, the question Y data 227, and the question Z data 228, which are combined with the program data 222. Then, the display processing section 9 causes, for example, the program described by the program data 222 to display on the display device 11, concurrently with the question X described by the question X data 226. In progress of the program, the question X, the question Y, and the question Z are displayed in succession on the display device 11. The viewer answers the questions X, Y, and Z.

In such a case, the viewing determination section 14 determines that the viewer has watched the program, when condition 1 is satisfied, and at least one of conditions 2 through 4 are satisfied. The conditions 1, 2, 3, and 4 are as follows:

Condition 1: the reception confirmation key extracting section 8 extracts a reception confirmation key from the broadcast data 220.

Condition 2: A viewer's answer to the question X is correct.

Condition 3: A viewer's answer to the question Y is correct.

Condition 4: A viewer's answer to the question Z is correct.

Alternatively, the viewing determination section 14 may determine that the viewer has watched the program when the condition 1 is satisfied and the conditions 2 through 4 are all satisfied. Here, that all of the viewer's answers are correct means a high possibility that the viewer has watched the program with a high degree of interest, not watched vaguely. Thus, the viewing determination section 14 can determine that the viewer has watched the program eagerly.

Alternatively, the viewing determination section 14 may determine that the viewer has watched the program when the condition 1 is satisfied and a predetermined particular condition among the conditions 2 through 4 is satisfied. That is, if an answer to the particular question is incorrect, it is determined that the viewer has not watched the program. The particular question is a question for asking about a key point of the program. If the viewer answers the particular question correctly, it means that the viewer has watched the program eagerly. Thus, the viewing determination section 14 can determine that the viewer has watched the program surely.

(Various Altered Examples)

The present invention is not limited to the description of the embodiments above, but may be altered by a skilled person within the scope of the claims. An embodiment based on a proper combination of technical means disclosed in different embodiments is encompassed in the technical scope of the present invention.

For example, the reception confirmation keys can be combined with the program data at fixed time intervals in the broadcast data. For example, the time interval is every one minute, five minutes, or ten minutes. The arrangement is particularly effective in the case when the program deals with topics that are unpredictable in advance, such as weather report and news.

Note that, in the broadcast data, the reception confirmation keys may be combined with the program data at arbitrary time intervals, instead at fixed time intervals. For example, the reception confirmation keys may be combined with the program data at points corresponding to important scenes of the program. Alternatively, the reception confirmation keys may be combined with the program data at points corresponding to commercial messages.

The broadcast data receiver 3 may be any device, such as television set, capable of receiving and reproducing programs. The broadcast data receiver 3 is preferably a mobile phone unit having a television capability.

The input device 12 may be any device, such as keyboard and mouse, capable of supplying user's entry of some kind of information to the broadcast data receiver 3. Further, the input device 12 and the broadcast data receiver 3 may be separated from each other. For example, the input device 12 may be a remote controller for controlling the broadcast data receiver 3. The input device 12 can transmit the information entered by the viewer by wireless to the broadcast data receiver 3, in compliance with an arbitrary wireless communications protocol such as IRSimple protocol.

The reception confirmation processing section 7 can identify a channel that carries a program being received by the broadcast data receiving section 5, by an arbitrary method. For example, the reception confirmation processing section 7 can identify a channel that carries a program from a channel identifier which is embedded in advance into broadcast data.

(Viewing Determination Program and Storage Medium)

Finally, each of the blocks included in the broadcast data receiver 3 may be realized by hardware logic or may be realized by software by means of a CPU (Central Processing Unit) as described below:

That is, the broadcast data receiver 3 includes a CPU that executes the order of a control program for realizing the aforesaid functions, ROM (Read Only Memory) that stores the control program, RAM (Random Access Memory) that develops the control program in executable form, and a storage device (storage medium), such as memory, that stores the control program and various types of data therein.

With this arrangement, the object of the present invention is realized by a predetermined storage medium. The storage medium stores, in computer-readable manner, program codes (executable code program, intermediate code program, and source program) of the control program of the broadcast data receiver 3, which is software for realizing the aforesaid functions. The storage medium is provided to the broadcast data receiver 3. With this arrangement, the broadcast data receiver 3 (alternatively, CPU or MPU) as a computer reads out and executes program code stored in the storage medium provided.

The storage medium for supplying the program codes to the broadcast data receiver 3 is not limited to a storage medium of particular structure and particular type. That is, this storage medium may be tape based, such as a magnetic tape or cassette tape; disc based, such as a magnetic disk including a floppy® disc and hard disk and optical disc including CD-ROM, MO, MD, DVD, and CD-R; card based, such as an IC card (including a memory card) and an optical card; or a semiconductor memory, such as a mask ROM, EPROM, EEPROM, and a flash ROM.

In order to achieve the objective of the present invention, the broadcast data receiver 3 may be arranged so as to be connectable to a communications network so that the program codes are supplied through the communications network to the broadcast data receiver 3. The communications network is not to be particularly limited, provided that the program codes are supplied to the broadcast data receiver 3 through it. Examples of the communications network includes the Internet, intranet, extranet, LAN, ISDN, VAN, CATV communications network, virtual private network, telephone network, mobile communications network, and satellite communications network.

A transmission medium constituting the communications network are not to be particularly limited, provided that it is any medium that can transmit the program codes. Examples of the transmission medium includes cables such as IEEE1394, USB (Universal Serial Bus), power-line carrier, cable TV lines, telephone lines, ADSL (Assymmetric Digital Subscriber Line) lines, and wireless connections such as IrDA and remote control using infrared light, Bluetooth®, 802.11, HDR, mobile phones, satellite connections, and terrestrial digital broadcasting. Note that the present invention can be also realized by the program codes in the form of a computer data signal embedded in a carrier wave which is embodied by electronic transmission.

As in the case of the broadcast data receiver 3, the viewing management server 4 can be also realized by a program and a storage medium. That is, the foregoing explanations for the broadcast data receiver 3 similarly apply to the viewing management server 4.

The present invention is widely used as a broadcasting system in which it can be accurately determined whether a viewer has watched a program.

Further, the broadcast receiving device according to the present invention is preferably arranged such that the reception means receives a program and receives a question presentation instruction key for instructing the presentation of the question, and the question presenting means which, after the reception means has received the question presentation instruction key, presents the question about the broadcast program to the viewer of the broadcast program.

According to the above arrangement, the question presenting means can present a question at a reception timing of the question presentation instruction key. For example, the question presenting means obtains question data from a database provided separately at a reception timing of the question presentation instruction key, and presents a question represented as the question data to the viewer.

This allows the broadcast receiving device to reliably present the question to the viewer at an appropriate timing even in the arrangement where the question data is not combined with program data in advance.

Still further, the broadcast receiving device according to the present invention is preferably arranged such that the viewing determination means identifies the broadcast program in accordance with the program identifier.

According to the above arrangement, the viewing determination means can identify the program that the reception means is receiving by checking the reception confirmation key that the reception means has received. This eliminates the need for separately obtaining program information such as an Electronic Program Guide. This allows the broadcast receiving device to more effectively identify the program that can be determined as a program that the viewer has watched.

Yet further, the broadcast receiving device according to the present invention is preferably arranged such that: the reception confirmation key includes a scene identifier that identifies a scene of the broadcast program; and the viewing determination means determines that the viewer has watched the scene of the broadcast program, in accordance with the scene identifier.

According to the above arrangement, the viewing determination means can more effectively identify the scene of the program that can be determined as a scene that the viewer is watching. Moreover, the program identifier is not necessary to be included in the reception confirmation key, so that it is possible to reduce the size of the reception confirmation key. Thus, it is possible to reduce a communications traffic volume required for the transmission of the reception confirmation key.

Further, the broadcast receiving device according to the present invention is preferably arranged such that: the viewing determination means identifies the broadcast program in accordance with program information regarding the broadcast program. For example, by using program information such as an Electronic Program Guide (EPG), the viewing determination means identifies the program which the viewer has watched. According to the above arrangement, the viewing determination means can more effectively identify the program that can be determined as a program that the viewer has watched.

Still further, the broadcast receiving device according to the present invention is preferably arranged such that the viewing determination means identifies the broadcast program in accordance with a time when the reception means has received the reception confirmation key.

According to the above arrangement, the viewing determination means identifies the program that the reception means is receiving, in accordance with a time when the reception means has received the reception confirmation key. This eliminates the need for separately obtaining program information such as an Electronic Program Guide. This allows the broadcast receiving device to more effectively identify the program that can be determined as a program that the viewer has watched.

Yet further, the broadcast receiving device according to the present invention is preferably arranged so as to further include incentive offering means which offers an incentive to the viewer when the viewing determination means determines that the viewer has watched the broadcast program.

According to the above arrangement, the incentive offering means offers an incentive of some kind to the viewer when the viewing determination means determines that the viewer has watched the broadcast program. For example, the incentive offering means offers the viewer a right to view a pay program for free, or reduces a charge for program viewing according to the number of programs that the viewer has watched.

This motivates the viewer to become more eager to watching the program, thus resulting in improvement of a program rating.

Further, the broadcast receiving device according to the present invention is preferably arranged so as to further include: incentive offering means which offers an incentive to the viewer when the viewing determination means determines that the viewer has watched the broadcast program; and informing means which informs the viewer of information regarding the incentive when the reception means has not yet received the reception confirmation key.

According to the above arrangement, the informing means informs the viewer of information regarding the incentive when the reception means has not yet received the reception confirmation key. This drives the viewer to keep watching the program at the aim of gaining such an incentive.

This allows the broadcast receiving device to improve a program rating.

Yet further, the broadcast receiving device according to the present invention is preferably arranged so as to further include: question presenting means which, when the viewing determination means determines that the viewer has watched the broadcast program, presents a question about the broadcast program to the viewer of the broadcast program; and incentive offering means which offers an incentive to the viewer when the viewer has answered the presented question correctly.

According to the above arrangement, the question presenting means presents the question about the program to the viewer, when the viewing determination means has determined that the viewer has watched the program. In such an arrangement, when the viewer has answered the question correctly, the incentive offering means offers an incentive to the viewer. For example, the incentive offering means offers the viewer a right to view a pay program for free, or reduces a charge for program viewing according to the number of programs that the viewer has watched.

With this arrangement, the broadcast receiving device motivates the viewer to become more eager to watching the program, thus resulting in improvement of a program rating. If it is impossible to determine that the viewer has watched the program, the broadcast receiving device does not present the question to the viewer. Thus, it is possible to prevent a viewer's act to obtain an incentive improperly.

Further, the broadcast receiving device according to the present invention is preferably arranged so as to further include: informing means which informs the viewer of information regarding the incentive when the viewing determination means determines that the viewer has not yet watched the broadcast program.

According to the above arrangement, the informing means informs the viewer of information regarding an incentive, when the viewing determination means has determined that the viewer has not yet watched the program. For example, the information includes (a) doing a quiz if the viewer has watched the program for a certain amount of time period and (b) offering a certain incentive if the viewer answers the quiz correctly. This drives the viewer to keep watching the program at the aim of gaining such an incentive. In addition, this drives the viewer to work hard to answer the presented quiz correctly. This allows the broadcast receiving device to improve a program rating.

As described above, a first broadcast receiving device according to the present invention includes the viewing determination means which determines that the viewer has watched the program, when the number of reception confirmation keys having been received by the reception means exceeds a predetermined reference value. This allows for more accurate determination as to whether the viewer has watched the program.

As described above, a second broadcast receiving device according to the present invention includes the viewing determination means which determines that the viewer has watched the program, when the reception points calculated from respective individual points for the received reception confirmation keys, the individual points being predetermined for each of the reception confirmation keys, exceeds a predetermined reference value. This allows for more accurate determination as to whether the viewer has watched the program.

As described above, a third broadcast receiving device according to the present invention includes the viewing determination means which determines that the viewer has watched the program, when the viewer has answered the present question correctly. This allows for more accurate determination as to whether the viewer has watched the program.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

1. A broadcast receiving device which receives a broadcast program and sequentially receives a plurality of reception confirmation keys by which reception of the broadcast program is confirmed,
the broadcast receiving device comprising:
reception means which receives the reception confirmation keys; and
viewing determination means which determines that a viewer has watched the broadcast program, when number of the reception confirmation keys, which have been received by the reception means, exceeds a predetermined reference value.

2. A broadcast receiving device which receives a broadcast program and sequentially receives a plurality of reception confirmation keys by which reception of the broadcast program is confirmed,
the broadcast receiving device comprising:
reception means which receives the reception confirmation keys; and
viewing determination means which determines that a viewer has watched the broadcast program, (a) when the reception means has received at least one predetermined particular reception confirmation key among the reception confirmation keys and (b) when number of the reception confirmation keys, which have been received by the reception means, exceeds a predetermined reference value.

3. A broadcast receiving device which receives a broadcast program and sequentially receives a plurality of reception confirmation keys by which reception of the broadcast program is confirmed,
the broadcast receiving device comprising:
reception means which receives the reception confirmation keys;
reception points calculating means which calculates reception points by adding respective individual points for the received reception confirmation keys, the individual points being predetermined for each of the reception confirmation keys; and
viewing determination means which determines that a viewer has watched the broadcast program, when the reception points thus calculated exceed a predetermined reference value.

4. A broadcast receiving device which receives a broadcast program and sequentially receives a plurality of reception confirmation keys by which reception of the broadcast program is confirmed,
the broadcast receiving device comprising:
reception means which receives the reception confirmation keys;
reception points calculating means which calculates reception points by adding respective individual points for the received reception confirmation keys, the individual points being predetermined for each of the reception confirmation keys; and
viewing determination means which determines that a viewer has watched the broadcast program, (a) when the reception means has received at least one predetermined particular reception confirmation key among the reception confirmation keys and (b) when the reception points thus calculated exceed a predetermined reference value.

5. A broadcast receiving device which receives a broadcast program, comprising:
reception means which receives the broadcast program;
question presenting means which, while the reception means receives the broadcast program, presents a question about the broadcast program to a viewer of the broadcast program; and
viewing determination means which determines that the viewer has watched the broadcast program, when the viewer has answered the presented question correctly.

6. A broadcast receiving device which receives a broadcast program and receives at least one reception confirmation key by which reception of the broadcast program is confirmed,
the broadcast receiving device comprising:
reception means which receives the reception confirmation key;
question presenting means which, after the reception means has received the reception confirmation key, presents a question about the broadcast program to a viewer of the broadcast program; and
viewing determination means which determines that the viewer has watched the broadcast program, when the viewer has answered the presented question correctly.

7. The broadcast receiving device according to claim 5, wherein:
the reception means receives the broadcast program and receives a question presentation instruction key for instructing the presentation of the question; and
the question presenting means, after the reception means has received the question presentation instruction key, presents the question about the broadcast program to the viewer of the broadcast program.

8. The broadcast receiving device according to claim 1, wherein:
the reception confirmation key includes a program identifier that identifies the broadcast program; and
the viewing determination means identifies the broadcast program in accordance with the program identifier.

9. The broadcast receiving device according to claim 1, wherein:
the reception confirmation key includes a scene identifier that identifies a scene of the broadcast program; and
the viewing determination means determines that the viewer has watched the scene of the broadcast program, in accordance with the scene identifier.

10. The broadcast receiving device according to claim 1, wherein:
the viewing determination means identifies the broadcast program in accordance with program information regarding the broadcast program.

11. The broadcast receiving device according to claim 1, wherein:
the viewing determination means identifies the broadcast program in accordance with a time when the reception means has received the reception confirmation key.

12. The broadcast receiving device according to claim 1, further comprising:
incentive offering means which offers an incentive to the viewer when the viewing determination means determines that the viewer has watched the broadcast program.

13. The broadcast receiving device according to claim 5, further comprising:
incentive offering means which offers an incentive to the viewer when the viewing determination means determines that the viewer has watched the broadcast program; and
informing means which informs the viewer of information regarding the incentive when the reception means has not yet received the reception confirmation key.

14. The broadcast receiving device according to claim 1, further comprising:
question presenting means which, when the viewing determination means determines that the viewer has watched the broadcast program, presents a question about the broadcast program to the viewer of the broadcast program; and
incentive offering means which offers an incentive to the viewer when the viewer has answered the presented question correctly.

15. The broadcast receiving device according to claim 14, further comprising:
informing means which informs the viewer of information regarding the incentive when the viewing determination means determines that the viewer has not yet watched the broadcast program.

16. A viewing determination method comprising:
reception step of receiving a broadcast program and sequentially receiving a plurality of reception confirmation keys by which reception of the broadcast program is confirmed; and
viewing determination step of determining that a viewer has watched the broadcast program, when number of the reception confirmation keys, which have been received in the reception step, exceeds a predetermined reference value.

17. A viewing determination method comprising:
reception step of receiving a broadcast program and sequentially receiving a plurality of reception confirmation keys by which reception of the broadcast program is confirmed; and
viewing determination step of determining that a viewer has watched the broadcast program, (a) when at least one predetermined particular reception confirmation key among the reception confirmation keys has been received in the reception step and (b) when number of the reception confirmation keys, which have been received by the reception means, exceeds a predetermined reference value.

18. A viewing determination method comprising:
reception step of receiving a broadcast program and sequentially receiving a plurality of reception confirmation keys by which reception of the broadcast program is confirmed;
reception points calculating step of calculating reception points by adding respective individual points for the received reception confirmation keys, the individual points being predetermined for each of the reception confirmation keys; and
viewing determination step of determining that a viewer has watched the broadcast program, when the reception points thus calculated exceed a predetermined reference value.

19. A viewing determination method comprising:
reception step of receiving a broadcast program and sequentially receiving a plurality of reception confirmation keys by which reception of the broadcast program is confirmed;
reception points calculating step of calculating reception points by adding respective individual points for the received reception confirmation keys, the individual points being predetermined for each of the reception confirmation keys; and
viewing determination step of determining that a viewer has watched the broadcast program, (a) when at least one predetermined particular reception confirmation key among the reception confirmation keys has been received in the reception step and (b) when the reception points thus calculated exceed a predetermined reference value.

20. A viewing determination method comprising:
reception step of receiving a broadcast program;
question presenting step of, while the broadcast program is received in the reception step, presenting a question about the broadcast program to a viewer of the broadcast program; and
viewing determination step of determining that the viewer has watched the broadcast program, when the viewer has answered the presented question correctly.

21. A viewing determination method comprising:
reception step of receiving a broadcast program and receiving at least one reception confirmation key by which reception of the broadcast program is confirmed,
question presenting step of, after the reception confirmation key has been received in the reception step, presenting a question about the broadcast program to a viewer of the broadcast program; and
viewing determination step of determining that the viewer has watched the broadcast program, when the viewer has answered the presented question correctly.

22. A viewing management server comprising:
reception means which receives information transmitted from a broadcast receiving device, the broadcast receiving device receiving a broadcast program and sequentially receiving a plurality of reception confirmation keys by which reception of the broadcast program is confirmed, the information being information regarding the reception confirmation keys that the broadcast receiving device has received;
number-of-reception-confirmation-keys calculating means which calculates number of the reception confirmation keys, which have been received by the broadcast receiving device, in accordance with the information having been received by the reception means; and
viewing determination means which determines that a viewer has watched the broadcast program, when the thus calculated number of the reception confirmation keys exceeds a predetermined reference value.

23. A viewing management server comprising:
reception means which receives information transmitted from a broadcast receiving device, the broadcast receiving device receiving a broadcast program and sequentially receiving a plurality of reception confirmation keys by which reception of the broadcast program is confirmed, the information being information regarding the reception confirmation keys that the broadcast receiving device has received;
number-of-reception-confirmation-keys calculating means which calculates number of the reception confirmation keys, which have been received by the broadcast receiving device, in accordance with the information having been received by the reception means;
particular key reception determination means which determines whether the broadcast receiving device has received at least one predetermined particular reception confirmation key among the reception confirmation keys, in accordance with the information having been received by the reception means; and
viewing determination means which determines that a viewer has watched the broadcast program, (a) when the particular key reception determination means determines that the broadcast receiving device has received the at least one predetermined particular reception confirmation key among the reception confirmation keys and (b) when the number of the reception confirmation keys, which has been calculated by the number-of-reception-confirmation-keys calculating means, exceeds a predetermined reference value.

24. A viewing management server comprising:
reception means which receives information transmitted from a broadcast receiving device, the broadcast receiving device receiving a broadcast program and sequentially receiving a plurality of reception confirmation keys by which reception of the broadcast program is confirmed, the information being information regarding the reception confirmation keys that the broadcast receiving device has received;
reception points calculating means which calculates reception points by adding respective individual points for the received reception confirmation keys, in accordance with the information having been received by the reception means, the individual points being predetermined for each of the reception confirmation keys; and
viewing determination means which determines that a viewer has watched the broadcast program, when the reception points thus calculated exceed a predetermined reference value.

25. A viewing management server comprising:
reception means which receives information transmitted from a broadcast receiving device, the broadcast receiving device receiving a broadcast program and sequentially receiving a plurality of reception confirmation keys by which reception of the broadcast program is confirmed, the information being information regarding the reception confirmation keys that the broadcast receiving device has received;
reception points calculating means which calculates reception points by adding respective individual points for the received reception confirmation keys, in accordance with the information having been received by the reception means, the individual points being predetermined for each of the reception confirmation keys;
particular key reception determination means which determines whether the broadcast receiving device has received at least one predetermined particular reception confirmation key among the reception confirmation keys, in accordance with the information having been received by the reception means; and
viewing determination means which determines that a viewer has watched the broadcast program, (a) when the particular key reception determination means determines that the broadcast receiving device has received the at least one predetermined particular reception confirmation key among the reception confirmation keys and (b) when the reception points thus calculated by the reception points calculating means exceeds a predetermined reference value.

26. A viewing management server comprising:
question presenting means which causes a broadcast receiving device, which receives a broadcast program, to present a question about the broadcast program to a viewer of the broadcast program, after confirming that the broadcast receiving device has received the broadcast program in accordance with information having been transmitted from the broadcast receiving device; and
viewing determination means which determines that the viewer has watched the broadcast program, when the viewer has answered the presented question correctly.

27. A viewing management server comprising:
question presenting means which causes a broadcast receiving device, which receives a broadcast program and receives at least one reception confirmation key by which reception of the broadcast program is confirmed, to present a question about the broadcast program to a viewer of the broadcast program, after confirming that the broadcast receiving device has received the reception confirmation key in accordance with information having been transmitted from the broadcast receiving device; and
viewing determination means which determines that the viewer has watched the broadcast program, when the viewer has answered the presented question correctly.

28. A broadcasting system comprising:
a broadcast receiving device which receives a broadcast program and sequentially receives a plurality of reception confirmation keys by which reception of the broadcast program is confirmed, the broadcast receiving device comprising: reception means which receives the reception confirmation keys; and viewing determination means which determines that a viewer has watched the broadcast program, when number of the reception confirmation keys, which have been received by the reception means, exceeds a predetermined reference value; and
a broadcast transmitting device which transmits the broadcast program and the reception confirmation keys to the broadcast receiving device.

29. A broadcasting system comprising:
a broadcast receiving device which receives a broadcast program and sequentially receives a plurality of reception confirmation keys by which reception of the broadcast program is confirmed, the broadcast receiving device comprising: reception means which receives the reception confirmation keys; and viewing determination means which determines that a viewer has watched the broadcast program, (a) when the reception means has received at least one predetermined particular reception confirmation key among the reception confirmation keys and (b) when number of the reception confirmation keys, which have been received by the reception means, exceeds a predetermined reference value; and
a broadcast transmitting device which transmits the broadcast program and the reception confirmation keys to the broadcast receiving device.

30. A broadcasting system comprising:
a broadcast receiving device which receives a broadcast program and sequentially receives a plurality of reception confirmation keys by which reception of the broadcast program is confirmed, the broadcast receiving device comprising: reception means which receives the reception confirmation keys; reception points calculating means which calculates reception points by adding respective individual points for the received reception confirmation keys, the individual points being predetermined for each of the reception confirmation keys; and viewing determination means which determines that a viewer has watched the broadcast program, when the reception points thus calculated exceed a predetermined reference value; and
a broadcast transmitting device which transmits the broadcast program and the reception confirmation keys to the broadcast receiving device.

31. A broadcasting system comprising:
a broadcast receiving device which receives a broadcast program and sequentially receives a plurality of reception confirmation keys by which reception of the broadcast program is confirmed, the broadcast receiving device comprising: reception means which receives the reception confirmation keys; reception points calculating means which calculates reception points by adding respective individual points for the received reception confirmation keys, the individual points being predetermined for each of the reception confirmation keys; and viewing determination means which determines that a viewer has watched the broadcast program, (a) when the reception means has received at least one predetermined particular reception confirmation key among the reception confirmation keys and (b) when the reception points thus calculated exceed a predetermined reference value; and
a broadcast transmitting device which transmits the broadcast program and the reception confirmation keys to the broadcast receiving device.

32. A broadcasting system comprising:
a broadcast receiving device which receives a broadcast program, comprising: reception means which receives the broadcast program; question presenting means which, while the reception means receives the broadcast program, presents a question about the broadcast program to a viewer of the broadcast program; and viewing determination means which determines that the viewer has watched the broadcast program, when the viewer has answered the presented question correctly; and
a broadcast transmitting device which transmits the broadcast program to the broadcast receiving device.

33. A broadcasting system comprising:
a broadcast receiving device which receives a broadcast program and receives at least one reception confirmation key by which reception of the broadcast program is confirmed, the broadcast receiving device comprising: reception means which receives the reception confirmation key; question presenting means which, after the reception means has received the reception confirmation key, presents a question about the broadcast program to a viewer of the broadcast program; and viewing determination means which determines that the viewer has watched the broadcast program, when the viewer has answered the presented question correctly; and
a broadcast transmitting device which transmits the broadcast program and the reception confirmation key to the broadcast receiving device.

34. A broadcasting system comprising:
a broadcast receiving device which receives a broadcast program and sequentially receives a plurality of reception confirmation keys by which reception of the broadcast program is confirmed; and
a viewing management server comprising: reception means which receives information transmitted from the broadcast receiving device, the information being information regarding the reception confirmation keys that the broadcast receiving device has received; number-of-reception-confirmation-keys calculating means which calculates number of the reception confirmation keys, which have been received by the broadcast receiving device, in accordance with the information having been received by the reception means; and viewing determination means which determines that a viewer has watched the broadcast program, when the thus calculated number of the reception confirmation keys exceeds a predetermined reference value.

35. A broadcasting system comprising:
a broadcast receiving device which receives a broadcast program and sequentially receives a plurality of reception confirmation keys by which reception of the broadcast program is confirmed; and
a viewing management server comprising: reception means which receives information transmitted from the broadcast receiving device, the information being information regarding the reception confirmation keys that the broadcast receiving device has received; number-of-reception-confirmation-keys calculating means which calculates number of the reception confirmation keys, which have been received by the broadcast receiving device, in accordance with the information having been received by the reception means; particular key reception determination means which determines whether the broadcast receiving device has received at least one predetermined particular reception confirmation key among the reception confirmation keys, in accordance with the information having been received by the reception means; and viewing determination means which determines that a viewer has watched the broadcast program, (a) when the particular key reception determination means determines that the broadcast receiving device has received the at least one predetermined particular reception confirmation key among the reception confirmation keys and (b) when the number of the reception confirmation keys, which has been calculated by the number-of-reception-confirmation-keys calculating means, exceeds a predetermined reference value.

36. A broadcasting system comprising:
a broadcast receiving device which receives a broadcast program and sequentially receives a plurality of reception confirmation keys by which reception of the broadcast program is confirmed; and
a viewing management server comprising: reception means which receives information transmitted from the broadcast receiving device, the information being information regarding the reception confirmation keys that the broadcast receiving device has received; reception points calculating means which calculates reception points by adding respective individual points for the received reception confirmation keys, in accordance with the information having been received by the reception means, the individual points being predetermined for each of the reception confirmation keys; and viewing determination means which determines that a viewer has watched the broadcast program, when the reception points thus calculated exceed a predetermined reference value.

37. A broadcasting system comprising:
a broadcast receiving device which receives a broadcast program and sequentially receives a plurality of reception confirmation keys by which reception of the broadcast program is confirmed; and
a viewing management server comprising: reception means which receives information transmitted from the broadcast receiving device, the information being information regarding the reception confirmation keys that the broadcast receiving device has received; reception points calculating means which calculates reception points by adding respective individual points for the received reception confirmation keys, in accordance with the information having been received by the reception means, the individual points being predetermined for each of the reception confirmation keys; particular key reception determination means which determines whether the broadcast receiving device has received at least one predetermined particular reception confirmation key among the reception confirmation keys, in accordance with the information having been received by the reception means; and viewing determination means which determines that a viewer has watched the broadcast program, (a) when the particular key reception determination means determines that the broadcast receiving device has received the at least one predetermined particular reception confirmation key among the reception confirmation keys and (b) when the reception points thus calculated by the reception points calculating means exceeds a predetermined reference value.

38. A broadcasting system comprising:
a broadcast receiving device which receives a broadcast program; and
a viewing management server comprising: question presenting means which causes the broadcast receiving device to present a question about the broadcast program to a viewer of the broadcast program, after confirming that the broadcast receiving device has received the broadcast program in accordance with information having been transmitted from the broadcast receiving device; and viewing determination means which determines that the viewer has watched the broadcast program, when the viewer has answered the presented question correctly.

39. A broadcasting system comprising:
a broadcast receiving device which receives a broadcast program and receives at least one reception confirmation key by which reception of the broadcast program is confirmed; and
a viewing management server comprising: question presenting means which causes the broadcast receiving device to present a question about the broadcast program to a viewer of the broadcast program, after confirming that the broadcast receiving device has received the reception confirmation key in accordance with information having been transmitted from the broadcast receiving device; and viewing determination means which determines that the viewer has watched the broadcast program, when the viewer has answered the presented question correctly.

40. A computer-readable storage medium storing a program for operating the broadcast receiving device according to claim 1, the program causing a computer to function as the respective means of the broadcast receiving device.

41. A computer-readable storage medium storing a program for operating the viewing management server according to claim 22, the program causing a computer to function as the respective means of the viewing management server.
